(19) United States
(12) Patent Application Publication
(10) Pub. No.: US 2023/0351332 A1
(43) Pub. Date: Nov. 2, 2023

(54) SYSTEM AND METHOD FOR GENERATING PRODUCER DATA AND FOR PLANNING BASED THEREON

(71) Applicant: RIGHTPLACEMENT PTY LTD, Hobart (AU)

(72) Inventor: Gilbert Paul SAWFORD, Sandy Bay (AU)

(21) Appl. No.: 18/169,650

(22) Filed: Feb. 15, 2023

Related U.S. Application Data
(63) Continuation of application No. 15/745,239, filed on Jan. 16, 2018, now abandoned.

(30) Foreign Application Priority Data
Jul. 13, 2015 (AU) 2015902770

(51) Int. Cl. G06Q 10/1053; G06Q 10/0631; G06Q 10/047; G06F 16/28; G06F 16/9535

(52) U.S. Cl. CPC G06Q 10/1053; G06Q 10/063112; G06Q 10/047; G06F 16/287; G06F 16/9535; G06F 3/0482

(57) ABSTRACT

The technical solution involves assessing a graphical representation of possible actions based upon previous and proven experiences or actions of others who have created actual paths from the source to the destination, and generating a virtual path in a convenient and efficient manner that may be the same as or different to these created paths.

### FIELD OF THE INVENTION

This invention relates to a system and method for generating producer data and for planning prospective pathways from a source to a destination based thereon. More particularly the invention relates to populating a database with historical data involving objects that are related to each other in time to create pathways and/or interrogating the database using search criteria associated with one or more objects within the database and displaying one or more pathways existing between the objects. The invention has particular utility for people in or interested in the workforce, who have had a career, or who are planning a career using equifinality principles.

Throughout the specification, including the claims, unless the context requires otherwise, the following terms have the specified meanings:
“comprise” or variations such as “comprises” or “comprising”, will be understood to imply the inclusion of a stated integer or group of integers but not the exclusion of any other integer or group of integers;
“destination” means a subsequent or successory object occurring at a particular point in time before the source;
“object” means a state, activity, event, action, location or similar, occurring at a point in time; and
“source” means an initial or predecessory object occurring at a particular point in time before the destination.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

Careers advice systems and methods have been used extensively in education and employment contexts over a long period of time to assist people to find employment, but more importantly, to enable them to follow a career path that is compatible with the strengths and interests of the particular individual involved. Notwithstanding the progress that has been made in both technology and psychology in understanding and facilitating the recruitment process and matching candidates to the desires of the employer, it is apparent that careers advice systems and methods in schools and further education establishments have largely failed to meet the needs of either people in transition or their educators or future employers. For example, the Australian workforce is currently around 11 million strong, with an annual turnover of 18.5%. This results in approximately 2,000,000 staff turnovers per year. There are also around 200,000 new entrants to the labour market per year, comprising people in transition from school and further education. Together, this amounts to approximately 2.2 million workplace transitions per year across the country.

Labour market research indicates that staff turnover costs are 1.5 times salary and with the average salary in Australia estimated by the Australian Bureau of Statistics at $50,000, this turnover costs the Australian economy around $150 billion per year.

The Australian post-primary education market is currently around 4.2 million students, with 1.5 million in Secondary school, almost one million attending university and 1.7 million undertaking vocational education training (VET) courses each year. The estimate of the total investment in employment-based training for apprentices and trainees is roughly $30 billion per annum and with 40% attrition, $12 billion of this investment is wasted and lost to the economy. The student attrition in Australia's universities alone comes at a cost of more than $1.4 billion a year, or an average of $36 million for each institution.

Research on student attrition shows that around 19% of university students and 40% of VET students do not complete their courses and that much of this attrition is connected to careers information and advice.

Against this backdrop, the advance of the Internet and cloud computing has seen prevailing recruitment processes moving to online access and the use of algorithms to sort applicants, maintaining an “objective” distance between employers and potential recruits. This approach appears to be contributing to the high turnover rates in the market place, rather than easing them.

One of the reasons for this is that these systems and methodologies are “transactional” in principle and have moved away from a more “relational” way of providing information and support. This has resulted in low participation in education and employment, high turnover in the workplace and high dropout rates in further education.

There have been many positive improvements in Careers Education and Development in Australia in recent years—the Australian Blueprint for Career Development being a good example. However there is still a need for tools and models which enable people in transition, educators and employers to find one another and to work their way through the maze of choices, challenges and opportunities they are each faced with in the complex 21^{st} century workforce.

### Disclosure of the Invention

It is an object of the present invention to facilitate planning making use of computer related technology and resources that operate in a more “relational” rather than a “transactional” way.

In achieving this object, the present invention addresses, and provides a technical solution to, the technical problem of how to go about planning a prospective path virtually and analytically, from a source to arrive at a desired future destination, where there may be one or many intermediary steps that can be taken, in addition to arriving at the destination directly.

The technical solution provided by the present invention involves assessing a graphical representation of possible actions based upon previous and proven experiences or actions of others who have created actual paths from the source to the destination, and generating a virtual path in a convenient and efficient manner that may be the same as or different to these created paths.

In accordance with a first aspect of the present invention, there is provided a production system for generating producer data representative of nodal objects and one or more links between them in a database of the producer data stored in a data store, each nodal object comprising informational content characterising an object state for the nodal object and one or more links to other related nodal objects, the production system including:
a user interface for receiving producer data input by a user of the production system having:
(i) an input process including a template of possible nodal object categories and sub-categories to be individually selected to define an object state of a producer; and
(ii) a specification generating process to create a specification of producer data comprising the object states of one or more nodal objects associated with a producer; and
a producer creation process for receiving the specification of producer data from the user interface for each nodal object created by the producer and populating the database with producer data derived from the specification of producer data, the nodal objects occurring sequentially at different chronological stages relative to the producer, or in parallel at either the same or overlapping chronological stages, the producer creation process having:
   (a) a linking process to link each nodal object in the specification to a predecessory nodal object or a successory nodal object to form a producer pathway for the producer, the linking process having a beginning nodal object, any intermediary nodal objects if they exist and an ending nodal object; and
   (b) a database populating process to populate the database with producer data defining the producer pathway.

Preferably, the user interface includes a filter to facilitate the user inputting data and invoking the input process and the specification generating process.

Preferably, the producer creation process further includes an integrating linking process to link each nodal object in a producer pathway to all predecessory nodal objects and successory nodal objects of other producers stored in the database having a corresponding nodal object.

Preferably, the specification generating process creates the specification of producer data sequentially, iteratively presenting one or more categories or sub-categories or both to the user for inputting producer data to define object states of subsequent nodal objects until a complete specification of all of the nodal objects of a producer is generated.

In accordance with a second aspect of the invention, there is provided a planning system for interrogating a database of data representing nodal objects in a data store, each nodal object comprising informational content characterising the nodal object and one or more links to other related nodal objects, the planning system including:
(a) a plurality of searching strategy processes for interrogating the database according to different searching strategies in response to input search data having a beginning specification for a nodal object so as to establish a ‘from’ nodal object, and an end specification for a nodal object so as to establish a ‘to’ nodal object,
(b) a results processing engine to receive and process the results of an interrogation of the database to locate nodal objects according to an initial searching strategy process and ascertain whether the searching strategy of that process is satisfied, or whether another searching strategy needs to be applied, and either outputting output data for reporting if the searching strategy of the initial searching strategy process is satisfied, or initiating another interrogation of the database for nodal objects according to the other searching strategy of a subsequent searching strategy process; and
(c) a database interrogating process to interrogate the database in accordance with the initial searching strategy process using the input search data to locate any ‘from’ nodal objects that are linked by a direct pathway to a ‘to’ nodal object or vice versa, and further interrogate the database in response to the results processing engine in accordance with the subsequent searching strategy process to locate any ‘from’ nodal objects that are indirectly linked to a ‘to’ nodal object by a plurality of pathways including one or more intermediary nodal objects, or vice versa; and
a user interface for configuring search data input by a user into beginning specification search data and end specification search data for input to the data processing system, and configuring output data for reporting from the data processing system for graphical presentation to the user.

Preferably, the user interface includes a filter to facilitate a user inputting data and initiating the subsequent searching process or processes to select the pathway level to apply for extracting intermediary nodal objects from the output data for graphical presentation to the user.

Preferably, the data processing system includes a nodal object generation process to:
(i) receive the beginning specification from the user interface to establish the ‘from’ nodal object;
(ii) provide the user interface with prescribed list information from which the end specification can be selected to establish the ‘to’ nodal object; and
(iii) apply the beginning specification and the end specification to the initial searching strategy process and the subsequent searching strategy process as required.

Preferably, the data processing system includes a producer creation process for populating the database with discrete nodal objects associated with a producer sequentially occurring at different chronological stages commencing with a beginning specification and finishing with an ending specification, and including specifications for all intermediary nodal objects, the producer creation process being designed to:
(i) receive specification data and producer data from the user interface for each nodal object created by the producer, along with other informational content characterising the nodal object;
(ii) link successive nodal objects and relate them so that all of the nodal objects form a pathway from the nodal object with the beginning specification to the nodal object with the ending specification; and
(iii) populate the database with data in respect of each of the related nodal objects in respect of which informational content is received; and
(iv) associate producer information with each of the related nodal objects populating the database.

Preferably, the data processing system includes a communication process to:
(i) receive a producer contact query from the user interface directed to related nodal objects of a producer displayed in the graphical presentation to the user;
(ii) access the data store to retrieve contact information from the user information of a producer associated with creating the related nodal objects; and
(ii) provide the user interface with the retrieved contact information for displaying to the user.

Preferably, the data processing system includes a virtual pathway creation process to use with the output data graphically presented to the user, the virtual pathway creation process being designed to:
(i) receive selections of intermediary nodal objects from the user interface to form a virtual pathway from the ‘from’ nodal object to the ‘to’ nodal object, disassociating the related nodal objects from the producer pathway as determined by the selection;
(ii) link related nodal objects between different producers as determined by the selection, retaining producer information between related nodal objects extracted from the database; and
(iii) store the virtual pathway as virtual data in the data store separately from the data populating the database as created by the producer creation process.

In accordance with a third aspect of the present invention, there is provided a user interface for a user to access a database of data representing nodal objects, each nodal object comprising informational content characterising the nodal object and one or more links to other related nodal objects, the interface including:
an interface generator for generating:
(a) an input user interface layout for inputting search data from a user to a data processing system for accessing the database: and
(b) an output user interface for outputting output data from the data processing system in the form of a graphical presentation to the user; wherein:
the input user interface layout has a field for configuring the search data into beginning specification search data and end specification search data; and
the output user interface has a pane for displaying the output data in respect of nodal objects sourced from the database as a result of processing by the data processing system diagrammatically as nodes, and directly related nodal objects that are linked by a lineal representation interconnecting the nodes;
whereby the nodes are displayed sequentially from one end of the pane to the other end of the pane, so that the node displayed at one end of the pane is a nodal object associated with the beginning specification of the beginning specification search data to establish a ‘from’ node and the node displayed at the other end of the pane is a nodal object associated with the ending specification of the ending specification search data to establish a ‘to’ node, so that the nodes collectively form one or more actual pathways between the ‘from’ node and the ‘to’ node.

Preferably, the output user interface is able to display multiple branches from one node to other intermediary nodes between the ‘from’ node and the ‘to’ node. Preferably, the pane is divided into a main display area for displaying the output data and a scratchpad display area for the user to create a virtual pathway using selected nodes from the main display area by dragging and dropping a chosen node from the main display area to the scratchpad display area.

Preferably, the interface generator includes a virtual display process for checking that selected nodes from the main display area are directly connected as related nodes in the actual pathway before verifying that the virtual pathway is valid.

In accordance with a fourth aspect of the present invention, there is provided a method for generating producer data representative of nodal objects and one or more links between them, each nodal object comprising informational content characterising an object state for the nodal object and one or more links to other related nodal objects, the method including:
receiving producer data input by a user that is individually selectable from a prescribed set of possible nodal object categories and sub-categories to define an object state of a producer;
creating a specification of producer data comprising the object states of one or more nodal objects associated with a producer;
receiving the specification of producer data for each nodal object created by the producer, the nodal objects occurring sequentially at different chronological stages relative to the producer, or in parallel at either the same or overlapping chronological stages;
linking each nodal object in the specification to a predecessory nodal object or a successory nodal object to form a producer pathway for the producer, the linking process having a beginning nodal object, any intermediary nodal objects if they exist and an ending nodal object; and
populating a database with producer data derived from the specification of producer data to define the producer pathway.

In accordance with a fifth aspect of the present invention, there is provided a method for interrogating a database of data representing nodal objects, each nodal object comprising informational content characterising the nodal object and one or more links to other related nodal objects, including:
interrogating the database according to different searching strategies in response to input search data having a beginning specification for a nodal object so as to establish a ‘from’ nodal object, and an end specification for a nodal object so as to establish a ‘to’ nodal object;
receiving and processing the results of an interrogation of the database to locate nodal objects according to an initial searching strategy process and ascertain whether the searching strategy of that process is satisfied, or whether another searching strategy needs to be applied, and either outputting output data for reporting if the searching strategy of the initial searching strategy process is satisfied, or initiating another interrogation of the database for nodal objects according to the other searching strategy of a subsequent searching strategy process;
interrogating the database in accordance with the initial searching strategy process using the input search data to locate any ‘from’ nodal objects that are linked by a direct pathway to a ‘to’ nodal object or vice versa, and further interrogating the database in response to the results processing module in accordance with the subsequent searching strategy process to locate any ‘from’ nodal objects that are indirectly linked to a ‘to’ nodal object by a plurality of pathways including one or more intermediary nodal objects, or vice versa; and
configuring search data input by a user into beginning specification search data and end specification search data for input to the data processing system, and configuring output data for reporting to the user.

In accordance with a sixth aspect of the present invention, there is provided a method for accessing a database of data representing nodal objects for processing, each nodal object comprising informational content characterising the nodal object and one or more links to other related nodal objects, the method including:
generating an input user interface layout for inputting search data from a user to a data processing system for accessing the database, and an output user interface for outputting output data in the form of a graphical presentation to the user after processing;
providing fields on the input user interface layout for configuring the search data into beginning specification search data and end specification search data on the input user interface layout;
presenting a pane on the output user interface for displaying the output data in respect of nodal objects sourced from the database diagrammatically as nodes, and linking directly related nodal objects by a lineal representation interconnecting the nodes as a result of processing; and
displaying the nodes sequentially from one end of the pane to the other end of the pane, so that the node displayed at one end of the pane is a nodal object associated with the beginning specification of the beginning specification search data to establish a ‘from’ node and the node displayed at the other end of the pane is a nodal object associated with the ending specification of the ending specification search data to establish a ‘to’ node, so that the nodes collectively form one or more actual pathways between the ‘from’ node and the ‘to’ node.

In accordance with another aspect of the present invention, there is provided a data processing system comprising: a production system as defined in the first aspect of the invention in paragraphs [14] to [17]; a planning system as defined in the second aspect of the invention in paragraphs [18] to [23]; and a user interface as defined in the third aspect of the invention in paragraphs [24] to [27].

In accordance with a further aspect of the present invention, there is provided a method for: (i) generating producer data representative of nodal objects and one or more links between them, each nodal object comprising informational content characterising an object state for the nodal object and one or more links to other related nodal objects as defined in the fourth aspect of the invention in paragraph [28]; (ii) interrogating a database of data representing the nodal objects as defined in the fifth aspect of the invention in paragraph [29]; and (iii) accessing a database of data representing the nodal objects for processing as defined in the sixth aspect of the invention in paragraph [30].

### BRIEF DESCRIPTION OF THE DRAWINGS

The invention will be better understood in the light of the ensuing description of the best mode for carrying out the invention. The description is made with reference to the following drawings of a specific embodiment of the best mode, wherein:

FIG. 1 is a schematic diagram of the client/server embodiment of the user interface system in an Internet environment;

FIG. 2 is a schematic block diagram of the general structure of the server of FIG. 1;

FIG. 3 is a series of schematic diagrams showing how the career nodes relate to each other in accordance with the specific embodiment; wherein:

FIG. 3A shows the relationship between a career node and a directly linked predecessory career node;

FIG. 3B shows the relationship between a career node and a directly linked successory career node; and

FIG. 3C shows the relationship between a career node and both the direct predecessor and direct successor;

FIG. 4 are schematic block diagrams showing the user interface; wherein:

FIG. 4A shows the producer creating process as configured by the process management engine when operating in the production system mode; and

FIG. 4B shows the process management engine when configured to operate in the planning system mode;

FIG. 5 is a schematic block diagram showing the arrangement of the user interface for inputting and outputting data from and to the interactive screen display;

FIG. 6A and FIG. 6B show the filter of the user interface in the form of an interactive screen display displaying a home page when the data processing system is initially invoked;

FIG. 7A and FIG. 7B show the initial interactive screen displays that are displayed when a user selects the data processing system to operate in a production mode and planning mode, respectivel;

FIG. 8 shows a series of web pages that are displayed from the menu bar of the data processing system shown in FIG. 7A when operated as a production system; wherein:

FIG. 8A is the web page displayed for education institution input;

FIG. 8B is the web page displayed for education qualification input;

FIG. 8C is the web page displayed for job role input;

FIG. 8D is the web page displayed for job function input;

FIG. 8E is the web page displayed for organisation input;

FIG. 8F is the web page displayed for industry input; and

FIG. 8G is the web page displayed for location input;

FIG. 9 shows a series of web pages that are displayed from the menu bar of the data processing system shown in FIG. 7B when operated as a planning system; wherein:

FIG. 9A is the web page displayed for education search;

FIG. 9B is the web page displayed for job role search;

FIG. 9C is the web page displayed for job function search;

FIG. 9D is the web page displayed for organisation search;

FIG. 9E is the web page displayed for industry search; and

FIG. 9F is the web page displayed for location search;

FIG. 10 are display screen shots produced by the output user interface showing how the career nodes based on data input by a producer are represented to a user of the system, wherein:

FIG. 10A displays career nodes and links for the first part of the particular producer's career; and

FIG. 10B displays career nodes and links for the second part of the producer's career;

FIG. 10C displays career nodes and links for the second part of the producer's career;

FIG. 11 are display screen shots showing how a virtual path is plotted by a user of the system, wherein:

FIG. 11A shows the commencement of the plot with the ‘from’ node and ‘to’ node entered onto the scratchpad and ready for an intermediary node to be plotted; and

FIG. 11B shows a virtual path created in the scratchpad with several intermediary nodes plotted;

FIG. 12 are a series of flowcharts describing different processes that form part of the data processing system, wherein:

FIG. 12A is a flowchart describing the producer creation process;

FIG. 12B is a flowchart describing the filter process;

FIG. 12C is a flowchart showing the search process followed by a consumer to interact with the nodal object generation process;

FIG. 12D is a flowchart describing the arm's length communication process;

FIG. 12E is a flowchart describing the virtual pathway creation process;

FIG. 13 is a flowchart showing the overall methodology adopted by the data processing system including the producer mode and the consumer mode;

FIG. 14 is a flowchart describing the searching methodology adopted by the system;

FIG. 15 are schematic diagrams showing how the career nodes relate to each other; wherein

FIG. 15A shows the relationship between a career node of User A and its predecessory and/or successory career nodes, and similarly the corresponding career nodes of User B;

FIG. 15B shows how the actual career pathways of many users comprising their respective career node datasets are overlaid to form a data pool; and

FIG. 16 is a schematic diagram showing an example of how the data processing system and methodology achieves equifinality from a generic set of structured data.

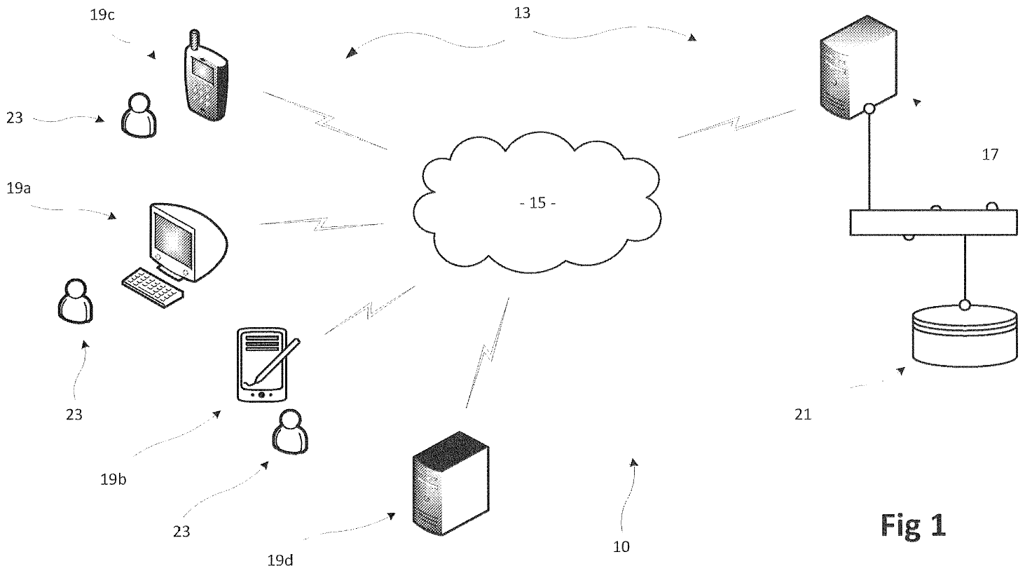

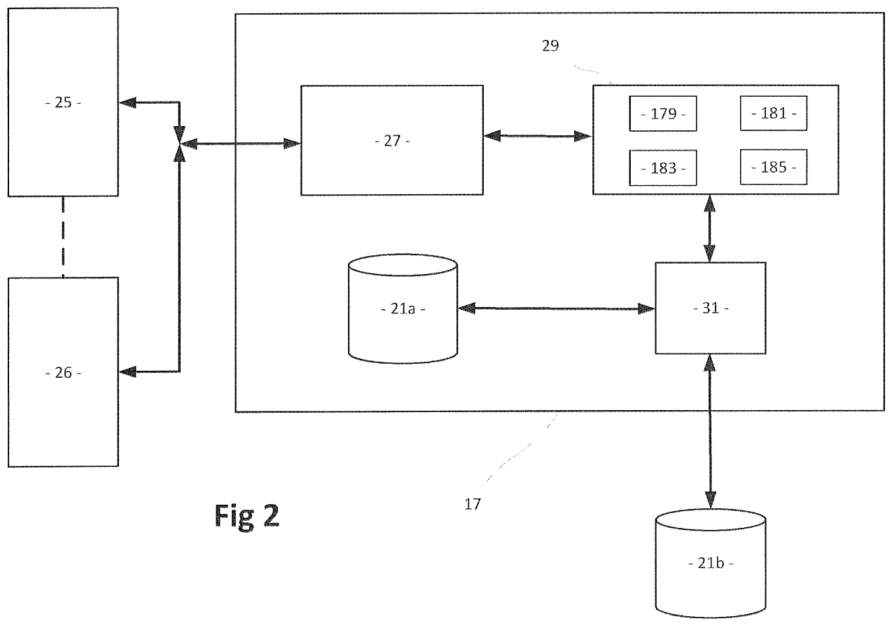

### BEST MODE(S) FOR CARRYING OUT THE INVENTION

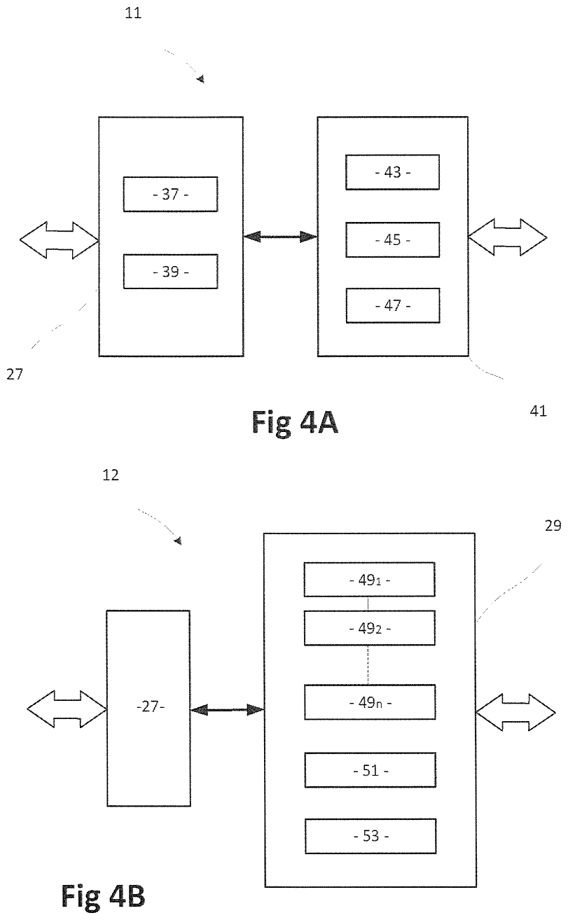

The best mode for carrying out the invention in one specific embodiment is implemented in a data processing system 10 and a method for processing data in a manner that operates in one mode as a production system 11 (FIG. 4A) for generating career paths of persons whom have had a career, and in another mode as a planning system 12 (FIG. 4B) for persons who are planning a career having regard to the career paths produced by the production system.

The data processing system 10 is effectively designed to allow users to define their possible potential career path and career goals, and to determine first steps towards achieving them. In general terms, this is achieved by users entering their career path, viewing the paths of others and creating virtual paths to set future goals based on the combination of the real paths of other uses.

Both the production system 11 and the planning system 12 use a common user interface 27 to facilitate interaction with the system by a user Other embodiments are also described that are directed towards variations and modifications of the one specific embodiment.

The data processing system 10 of the specific embodiment is implemented in a client/server arrangement 13 disposed in an Internet environment 15, which can take advantage of cloud computing resources. Other embodiments involve implementing the system in an intranet environment that involves a local area network (LAN), which is hard wired via Ethernet in full or in part with wireless, or in a wireless configuration in full, or in part with a hardwired LAN.

In the present embodiment, a server 17 hosts a web service for providing the data processing system 10 remotely to a number of clients 19 and includes high power computing services with appropriate speed and processing power to access a database 21 stored in a data store to service a large number of clients located in different geographical locations.

A client 19 can be any suitable computing device by which a user 23 can access the server 17 using a client web application 25 or can alternatively be a network Input/Output (I/O) interface 26 that allows system-to-system communication.

For example, a client 19 can be a desktop personal computer 19a, a tablet 19b, a smartphone 19c or a notebook computer (not shown) that can operate a browser to access a website hosted by the server 17 over the Internet 15. Alternatively or additionally, a client 19 can be a convertible computer (not shown), tablet 19b or smartphone 19c that can download a client application 25 in the form of an app associated with the system 11 and operate the app to access the server 17.

Further still, in system-to-system communication a client 19 can be another server 19d of another computer system that runs, for example, enterprise resource planning (ERP) software that permits the client application on it to be integrated with other application software forming part of the other computer system.

The server 17 includes various modules including a user interface 27, a process management engine 29 and a database management system (DBMS) 31.

The user interface 27 comprises executable code that follows instructions provided by the process management engine 29 to render the input and output displays on physical devices for the purpose of collecting and displaying data and information specific to the data processing system 10 from the client application 25 or network I/O interface 26 of the clients 19 and the database 21.

The process management engine 29 comprises executable code that follows instructions from the program code controlling its operation, consisting of logical and sequential statements that are necessary for interacting with the user interface 27 and the database 21 via the DBMS 31, for receiving input data and generating the output of the data processing system 10.

The DBMS 31 comprises executable code that follows instructions provided by the process management engine 29 to store data to, and retrieve data from, the particular data store that stores the database 21, being the necessary data that is required by the process management engine 29 to carry out the method performed by the data processing system 10.

The database 21 may be located in an internal data store 21a forming part of the server 17, or located in an external data store 21b externally of the server, or distributed across both internal and external data stores.

Each client application 25 and network I/O interface 26 comprises executable code to receive and process instructions from the user interface 27 relative to the client device 19 that supports the particular client application or I/O interface.

The program code of the process management engine 29 is designed to provide both the production system 11 and the planning system 12 modes of operating the data processing system 10.

In the case of the production system 11, the process management engine 29 populates the database 21 with data representing nodal objects, where each nodal object comprises informational content characterising the nodal object and one or more links to other related nodal objects.

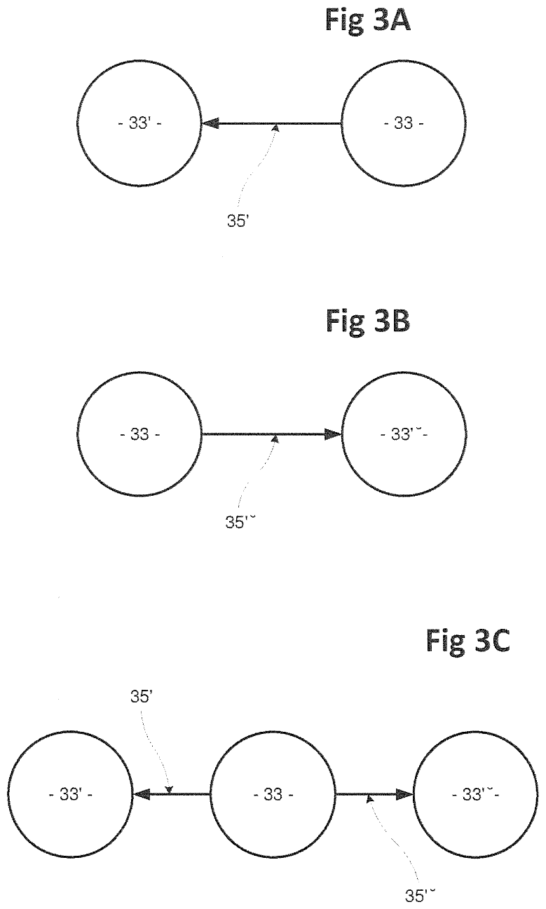

In the present embodiment, which is specifically applicable to career planning, as shown in FIG. 3, each nodal object represents a career node 33 of a person and includes informational content relating to: (i) the education of that person; (ii) the discrete work or job role and function performed by that person; and (ii)) the organisation, industry and location details associated with the job role and function.

The career node 33 also includes one or more links 35, to other career nodes. These career nodes 33 are either directly predecessory nodes 33′ representing the immediate previous work role performed by that person and are associated by the link 35′ as shown in FIG. 3A, or directly successory nodes 33″ representing the immediate subsequent work role performed by that person and are associated by the link 35″ as shown in FIG. 3B. In either case, the predecessory or successory career node 33′ or 33″ respectively has the applicable or requisite educational qualification associated or held by the person performing that previous or subsequent work role, recorded in a memory location of the store together with the specified work role.

It should be appreciated that with a person's current career status, their current career node 33 will represent their ending nodal object, as they will not yet have a successory career node, and only have their predecessory career 33′ as shown in FIG. 3A ‘from’ which that person advanced as the ‘source’ or progressed their career ‘to’ their current career role as the ‘destination’.

With a person just starting out on their career path, the converse applies where they will not have a predecessory career node yet and only have their current career node 33 and a notional successory career node 33″ as the ‘destination’ as shown in FIG. 3B ‘to’ which that person may intend to advance of progress their career. In this case the current career node 33 will represent their starting nodal object as the ‘source’. On most occasions, such a person would be a student or have recently been a student and as such would have their current career node populated with their Education history. In this case, their predecessory node will be an education node and the object of that node will be a course at an education institution. This will often be the starting point for the development of a virtual path being a hypothetical career path that may be constructed for recent students of recent graduates.

The same relationship schematic applies if that person has moved ‘to’ a second career role and is looking back at their history from the perspective of their starting career role represented by the career node 33 where their second and perhaps current career role ‘to’ which they are advancing or progressing is represented by the successory career node 33″.

If one looks at the person's career part way along their career path, then the particular career role under scrutiny will be represented by the career node 33, and have a predecessory career node 33′ representing a ‘from’ nodal object and a successory career node 33″ representing a ‘to’ nodal object, as shown in FIG. 3C. On the other hand, if one looks at the person's actual career path from start to finish or from start to current role, the pathway will commence with a starting nodal object represented by a ‘starting’ node, have a plurality of intermediary nodal objects represented by ‘intermediary’ nodes and end with an ending nodal object represented by an ‘ending’ node.

Thus the database 21 is populated with data in respect of all of the “from” and ‘to’ nodal objects constituting the career paths of a number of persons, the more persons with diverse career paths, then the better is the database for serving operation of the planning system 11.

In the present embodiment, the people whose career paths populate the database 21 are known as ‘producers’, Producers constitute anyone that has had a career or is currently part way through their career path, at any stage of their career. It is expected or anticipated that all users of the system will enter data as a “producer”, even though they may have only one predecessor node, particularly if they are still at school

In order to populate the database 12 with producer data representative of nodal objects in the form of career nodes 33 and links to predecessory career nodes and successory career nodes, the data processing system 10 is operated in the production system mode. In this mode the production system 11, configures the user interface 27 and invokes the process management engine 29 to operate a number of processes. The processes are designed to receive producer input to the production system by a user and generate producer data representative of nodal objects in the form of career nodes 33, and links between them, to create producer pathways. These pathways populate the database 21 and are integrated with previous producer data stored in the database.

As shown in FIG. 4A, the user interface 27 includes an input process 37 and a specification generating process 39 to achieve this. The input process 37 provides a template of possible nodal object categories and sub-categories to the user that are individually selectable to define an object state of a producer.

The specification generating process 39 is programmed to create a specification of producer data comprising the object states of one or more nodal objects associated with a producer.In the present embodiment, the specification generating process 39 is programmed to create the specification of producer data sequentially in an iterative manner. This is done by presenting one or more categories or sub categories or both to the user for inputting producer data to define object states of subsequent career nodes 33 until a complete specification of all of the career nodes of a producer is generated.

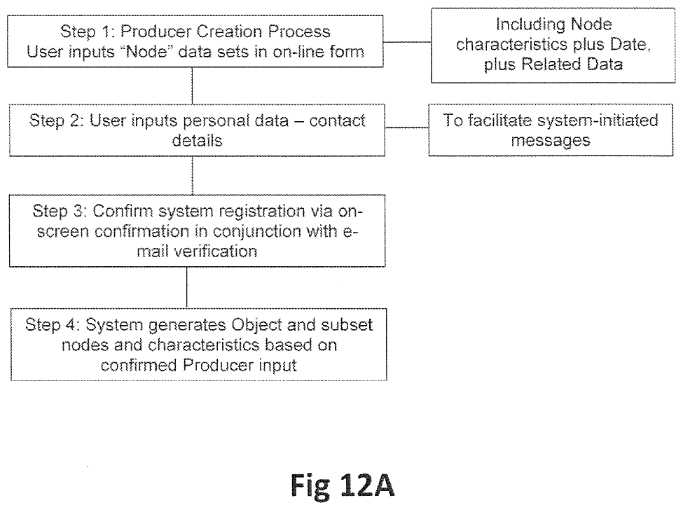

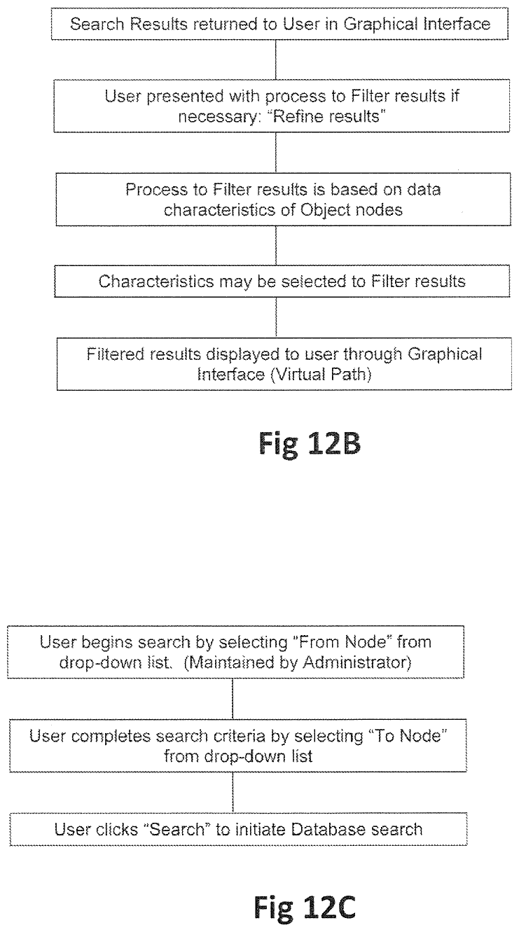

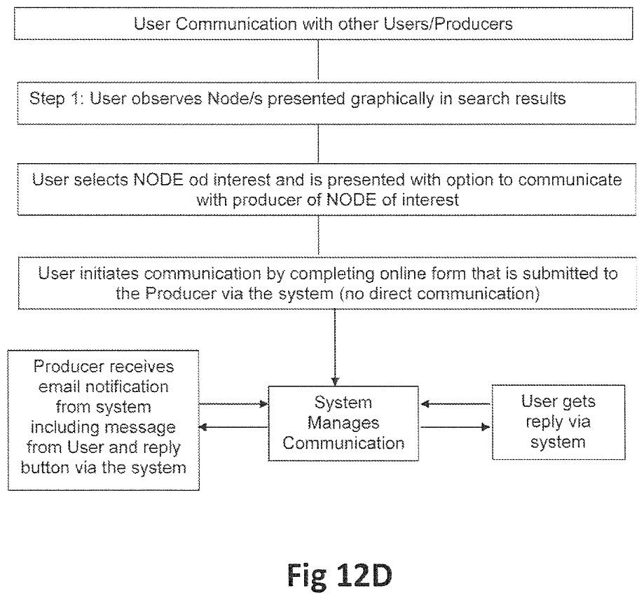

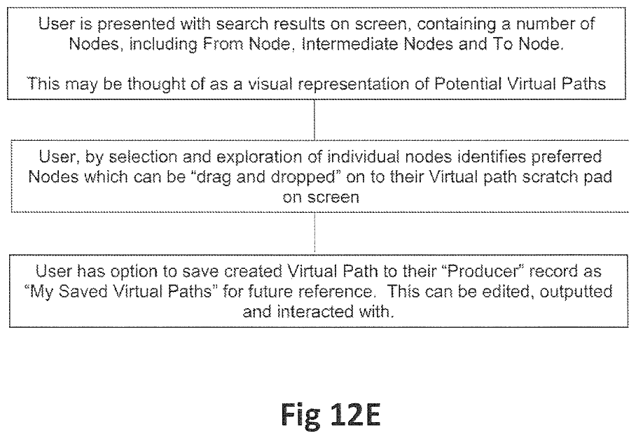

The process management engine 29 invokes a producer creation process 41 for receiving the specification of producer data from the user interface 27 for each career node 33 created by the producer and populating the database 21 with producer data derived from the specification of producer data produced by the specification generating process 39. The general process followed by the reduction system 11 to create a producer using the producer creation process 41 is described by the flowchart in FIG. 12A.

As previously described, the career nodes 33 can occur sequentially at different chronological stages relative to the producer, but they may also occur in parallel at either the same time as, or overlapping chronologically with one or more careers nodes 33. For example, a producer may have two or more part time job roles, or be involved with a community related service project at the same time as or during a number of different job roles. The producer creation process 41 in the present embodiment is able to deal with either.

To achieve this, the producer creation process 41 includes a linking process 43, a database populating process 45 and an integrating linking process 47. The linking process 43 is programmed to link each career node 33 in the specification to a predecessory career node 33′ or a successory career node 33 to form a producer pathway for the producer having a beginning career node, any intermediary career nodes if they exist and an ending career node.

The database populating process 45 is programmed to populate the database 21 with producer data defining the producer pathway. The integrating linking process 47 is programmed to link each career node 33 in a producer pathway to all predecessory career nodes 33′ and successory career nodes 33″ of other producers stored in the database having a corresponding career node 33. In order to make use of the database 21 once populated with data representing the career nodes 33 of various producers in the data store, the data processing system 10 is operated in the planning system mode. In this mode, the planning system 12 configures the user interface 27 and the process management engine 29 is invoked to operate a number of specifically designed processes to search or interrogate the database 21 for prescribed career nodes 33 and identify virtual pathways between the career nodes. As shown in FIG. 4B, these processes include a plurality of searching strategy processes 49, a database interrogating process 51 and a results processing module 53.

The searching strategy processes 491. are initiated for deployment by the process management engine 29 in response to specific search requests input by users 23 of the planning system 12, who in the present embodiment are known as ‘consumers’.

Consumers constitute anyone wishing to interrogate the database 21 in relation to researching virtual career paths created from actual career paths of producers that are stored in the database. From the collective data and information stored of many producers, a virtual career path can be determined that may be suitable for them or another person to whom this may be applicable.

These searching strategies 49₁₋ₙ are individually and automatically deployed by the process management engine 29, after a consumer initiates a search request, according to an overarching iterative process provided by the process management engine for interrogating the database 21, depending upon the particular search data input by the user to initially scope the search according to their purpose and the results obtained from the search. The deployment is performed by the process management engine 29 in a sequential manner, commencing with an initial searching strategy 49₁, and then, depending upon the results of this searching strategy, invoking subsequent searching strategies 49₂₋ₙ to produce a result within a range set by the consumer

The specific search requests are derived from a user being invited to input search data via a client 19 using the user interface 27 so that it has a beginning specification for a nodal object to establish a ‘from’ nodal object as the source, and an end specification for another nodal object to establish a ‘to’ nodal object as the destination. From this search data, an instance of the searching strategy processes 49 is initiated by the process management engine 29 and the database interrogating process 51 is invoked.

The database interrogating process 51 is programmed to interrogate the database 21 in accordance with the initial searching strategy process using the input search data to locate any ‘from’ nodal objects that are linked by a direct pathway to a ‘to’ nodal object or vice versa, and provide the results of such interrogation to the results processing module 53. Depending upon the outcome of the process performed by the results processing module 53, the database interrogating process 51 interrogates the database 21 using subsequent searching strategy processes to locate any ‘from’ nodal objects that are indirectly linked to a ‘to’ nodal object by a plurality of pathways including one or more intermediary nodal objects, or vice versa.

The results processing module 53 performs a plurality of iterative functions. According to a first step, it receives and processes the results of an interrogation of the database 21 arising from the deployment of the instance of the initial searching strategy process 49₁ by the database interrogation process 51 to locate nodal objects according to the initial searching strategy and ascertain whether the initial searching strategy of that process is satisfied, or whether another instance of the searching strategy needs to be applied Then according to a second step, it either outputs output data for reporting if the searching strategy of the initial searching strategy process is satisfied, or if not satisfied, initiates another interrogation of the database by the database interrogation process 51 for nodal objects using the second searching strategy process 49₂. It then repeats the second step for the second searching strategy process 49₂, and continues to repeat the first and second steps with subsequent searching strategy processes, if the preceding searching strategy process is not satisfied, reducing or expanding upon the range of the search until the requisite result is obtained.

Thus in the present embodiment, a user 23 of the overall system may be:
(i) a producer who populates the database 21 with nodal object data and information pertaining to their own career path or that of another person whom they are representing, during which time the data processing system 10 is running in the production mode as a production system 11; or
(ii) a consumer who uses the search and reporting system 11 to interrogate or search the database 21 according to a particular searching strategy designed for their purpose, during which time the data processing system 10 is running in the planning mode as a planning system 12.

In either case, the user interface 27 is situated on the server 17 and provides a communication interface with the client applications 25 and/or network V/O interfaces 26 of the clients 19 to enable a user 23 in the case of being either a producer or consumer to access the database 21.

In the planning system mode, the user interface 27 is programmed to configure search data input by a consumer. This configuring separates the input search data into beginning specification search data and end specification search data, which is input to the process management engine 29. The user interface 27 is also programmed to configure output data for reporting from the process management engine 29 for graphical presentation to the consumer.

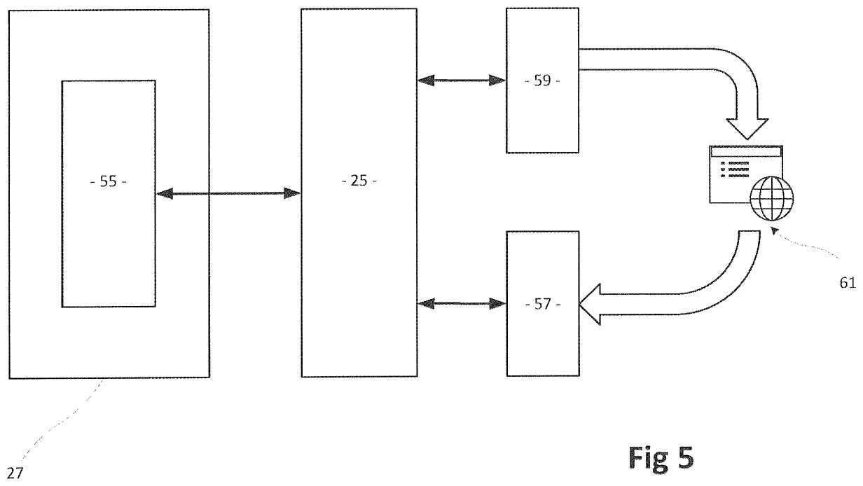

As shown in FIG. 5, the user interface 27 more particularly comprises an interface generator 55 for communicating with a client application 25 of the client 19 to generate an input user interface layout 57 and an output user interface 59 that are integrated into a single interactive screen display 61 for input/output with a user by means of the particular client 19 with which the user is interacting with the client application.

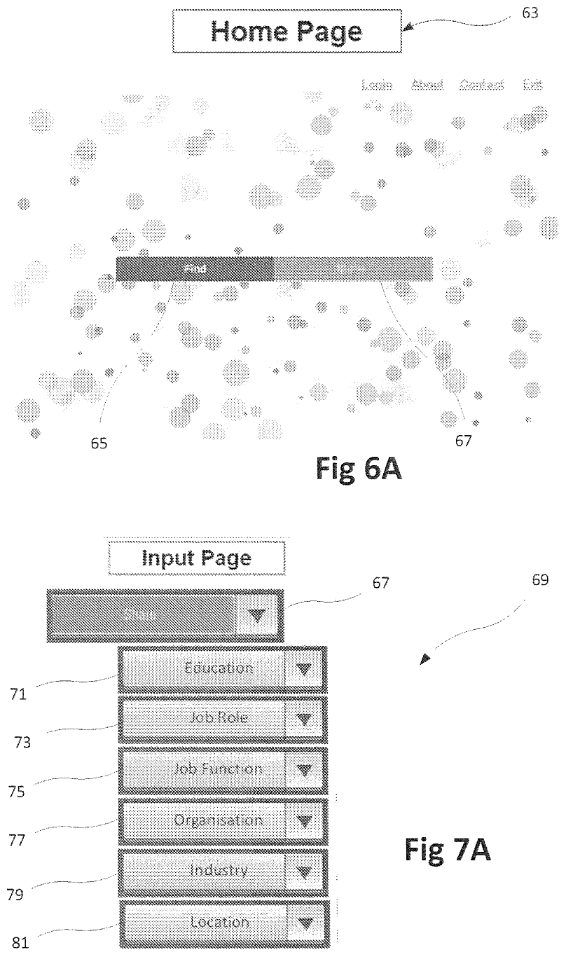

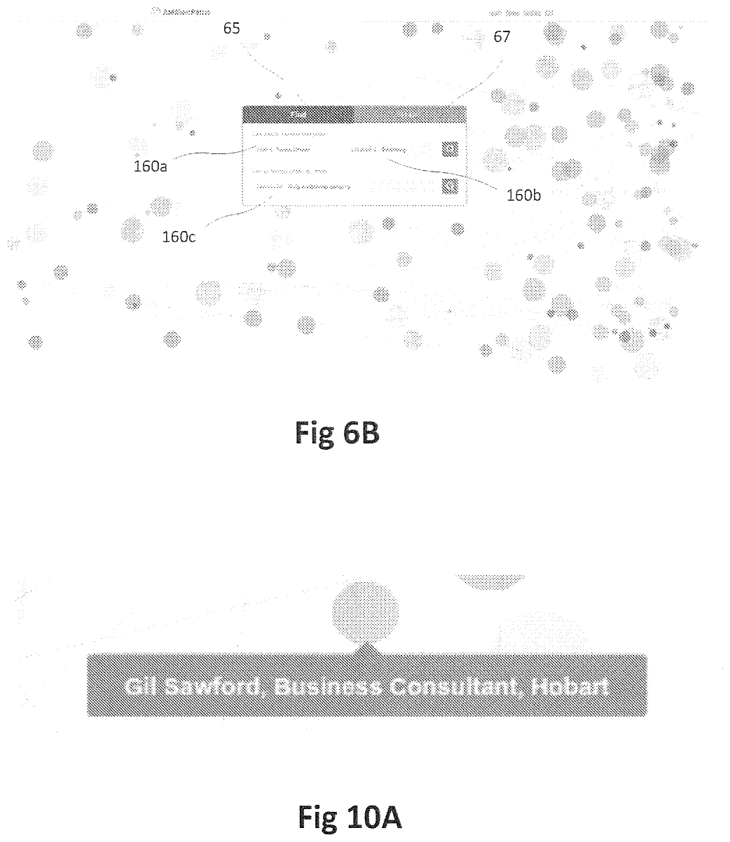

As shown in FIGS. 6 to 9, the interactive screen display 61 in the present embodiment presents a number of web pages that comprise fields, in which data may be entered, and controls or widgets for acting on the data to constitute the input user interface layout 57.

These widgets include a menu system that is designed to function as a filter to facilitate a user inputting data into prescribed fields of the input user layout 57 of the interactive screen display 61, and invoking or initiating other processes of the user interface 27 in one of two ways. The first way is when the data processing system 10 is operating as a production system 11 in the production system mode. The user asserts a push button provided on the particular menu displayed on a web page, and the input process 37 and the specification generating process 39 of the user interface 27 are invoked. The second way is when the data processing system 10 is operating as a planning system 12 in the planning system mode. The user asserts a push button provided on the particular menu displayed and the subsequent searching strategy process or processes 49 for deployment by the process management system 29 are initiated for the user to select the pathway level to apply for extracting intermediary nodal objects from the output data for graphical presentation to the user. The flowchart describing the process more particularly is shown in FIG. 12B.

More specifically in the present embodiment, the navigation menu includes a home page 63 shown in FIG. 6A having a ‘Find’ press button 65 for invoking the planning system 12 by a consumer, and a ‘Share’ press button 67 for invoking the production system 11.

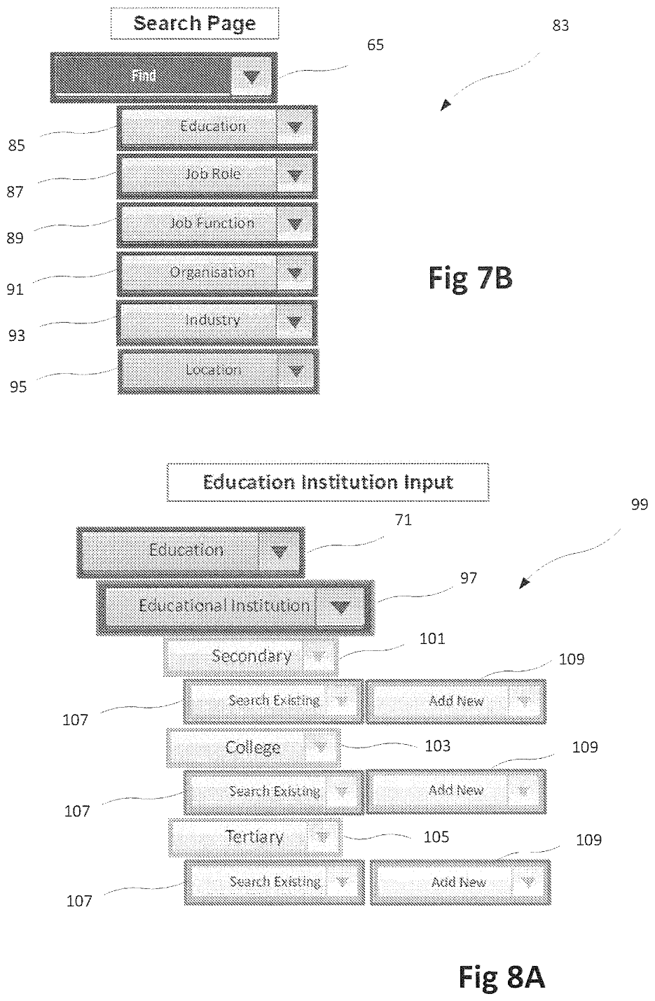

In the case of invoking the production system mode a user presses the ‘Share’ press button 67, and the navigation menu progresses by the user interface 27 presenting a web page with a menu 69 as shown in FIG. 7A. The menu 69 shows a series of sub menus provided by way of an ‘Education’ button 71, a ‘Job Role’ button 73, a Job Function button 75, an ‘Organisation’ button 77, an Industry button 79 and a ‘Location’ button 81, which the user interface 27 cycles through for each career step undertaken by a person in order to enable a user to enter data into the data processing system 10 and have it stored within the database 21 by way of the DBMS 31. This is done in a sequential manner beginning with the educational pathway of the person, and then considering their jobs.

In the case of initiating the planning system mode, a user asserts the ‘Find’ press button 65, and the navigation menu progresses so that the user interface 27 presents a web page with a similar but alternative menu 83 as shown in FIG. 78 for the purposes of accessing the data stored in the database 21 by way of the DBMS 31. As shown, the menu 83 shows a series of sub-menus provided by way of another set of the same types of buttons, namely an ‘Education’ button 85, a Job Role' button 87, a ‘Job Function’ button 89, an ‘Organisation’ button 91, an ‘Industry’ button 93 and a ‘Location’ button 95.

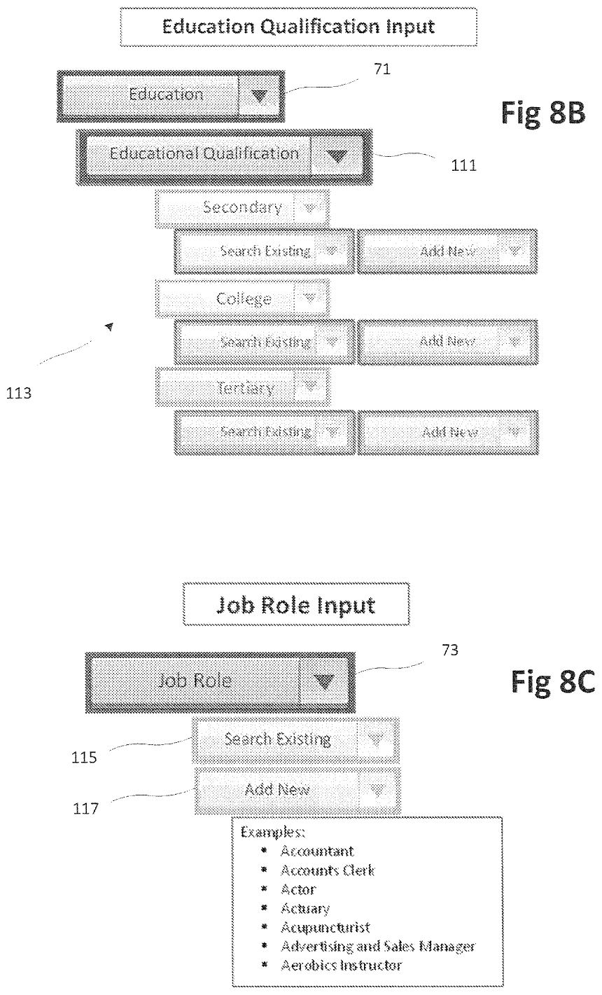

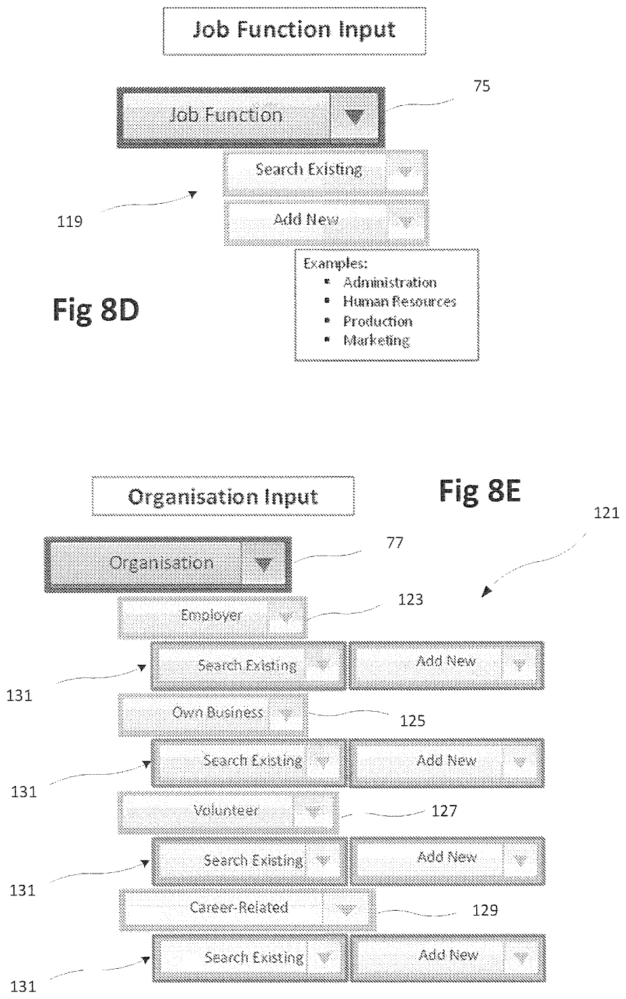

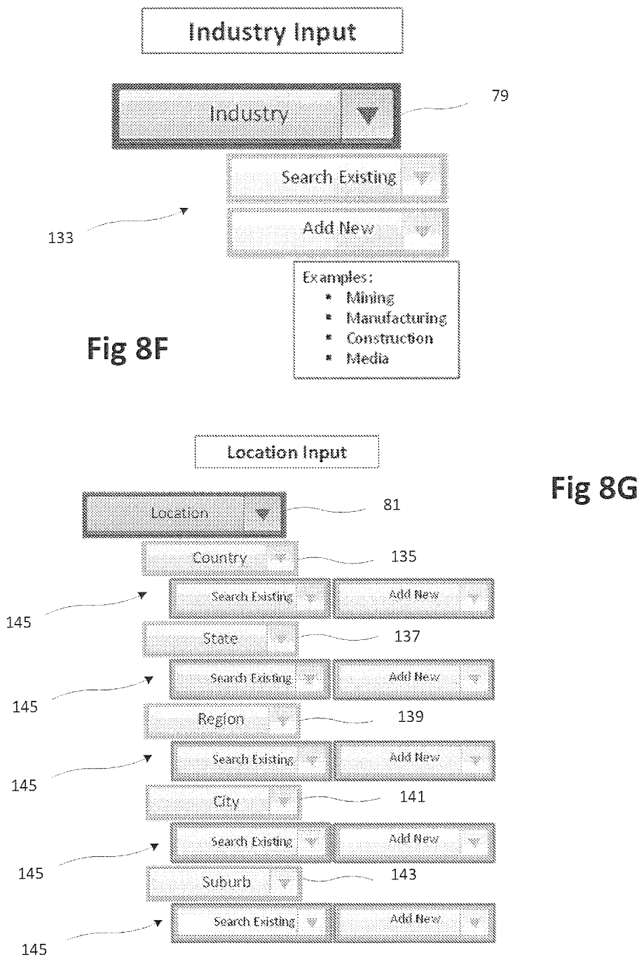

In the production system mode, the navigation menu is designed so that the ‘Education’ button 71 provides a mechanism for the user to input data by way of two options. One option is for specifying the educational institution that a user may wish to enter by way of the ‘Educational Institution’ button 97, which may be further broken down by the sub-menu structure 99 shown in FIG. 8A. The sub-menu structure 99 provides for the secondary, college and/or tertiary institutions to be selected by way of the drop down menu buttons ‘Secondary’ 101, ‘College’ 103 and ‘Tertiary’ 105 respectively. Each of these buttons provides for the user to enter an existing educational institution that may be searched by ‘Search Existing’ drop down menu buttons 107, or by adding a new institution by way of ‘Add New’ drop down menu buttons 109.

The other option is for specifying the educational qualification that a user may wish to enter by way of the ‘Educational Qualification’ button 111. As shown in FIG. 8B, a sub-menu structure 113 that is similar by way of the button layout to the sub-menu structure 99 of the educational institution option is provided to enter the relevant qualification. In this manner, within the educational qualification sub-menu structure 113, the user is able to search existing educational qualifications for secondary, college and tertiary institutions or add new qualifications.

After entering the educational data and continuing in the production system mode, the navigation menu is designed to enable a user to then input data relating to the particular jobs a person has undertaken throughout their career in chronological order. In the present embodiment, this is structured to commence with the job role, as shown in FIG. 3C, where the ‘Job Role’ button 73 provides for the user to use either the ‘Search Existing’ drop down menu button 115 to allow the user to search existing job roles for the applicable job role, or the ‘Add New’ drop down menu button 117 to add in a new job role if it doesn't exist. Examples of job roles are: Accountant, Accounts Clerk, Actor, Actuary, Acupuncturist, Advertising and Sales Manager, Aerobics Instructor etc.

The user interface 27 progresses within the navigation menu to display a job function menu page where, as shown in FIG. 8D, the Job Function' button 75 allows for the user to input data relating to a person's job function. In the present embodiment the job function is a sub-level classification relative to a person's job role, and data for this is again entered by using the ‘search existing’ and ‘add new’ drop down menu button facility 119. Examples of job functions include: Administration, Human Resources, Production, Marketing, etc.

Next, as shown in FIG. 8E, the user interface 27 progresses within the navigation menu to display the organisation menu page where the ‘Organisation’ button 77 provides for the user to input data relating to the name and status of an organisation with which they performed the particular job role and job function using the sub-menu arrangement 121. The status of organisation is filtered first using the drop down menu buttons ‘Employer’ 123, ‘Own Business’ 125, ‘Volunteer’ 127 and ‘Career Related’ 129. The ‘search existing’ and ‘add new’ drop down menu button facility 131 is again used to interrogate the database 21 to select the name of an organisation that has been previously entered, or to add it as a new name.

The user interface 27 then progresses to the industry menu page within the navigation menu where, as shown in FIG. 8F, the ‘Industry’ button 79 allows the user to input data regarding the particular industry sector to which the job related by using the ‘search existing’ and ‘add new’ drop down menu button facility 133. Examples of particular industries include: Mining, Manufacturing, Construction, Media etc.

Finally, the user interface 27 progresses to the location input page within the navigation menu, where, as shown in FIG. 8G, the ‘Location’ button 81 provides for the location to be filtered using the drop down menu buttons ‘Country’ 135, ‘State’ 137, ‘Region’ 139, ‘City’ 141 and ‘Suburb’ 143. Data is again entered using the ‘search existing’ and ‘add new’ drop down menu facility 145.

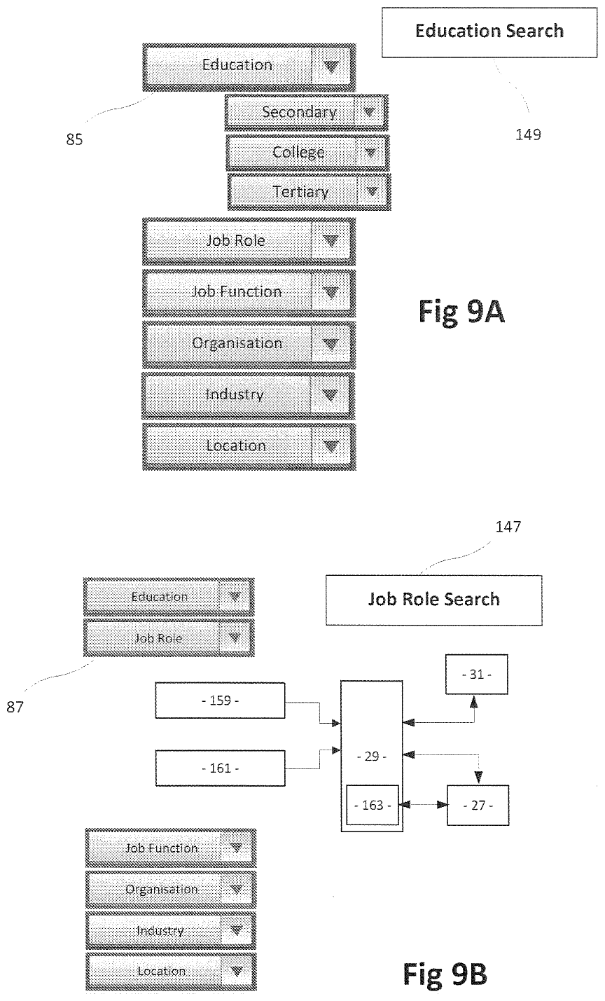

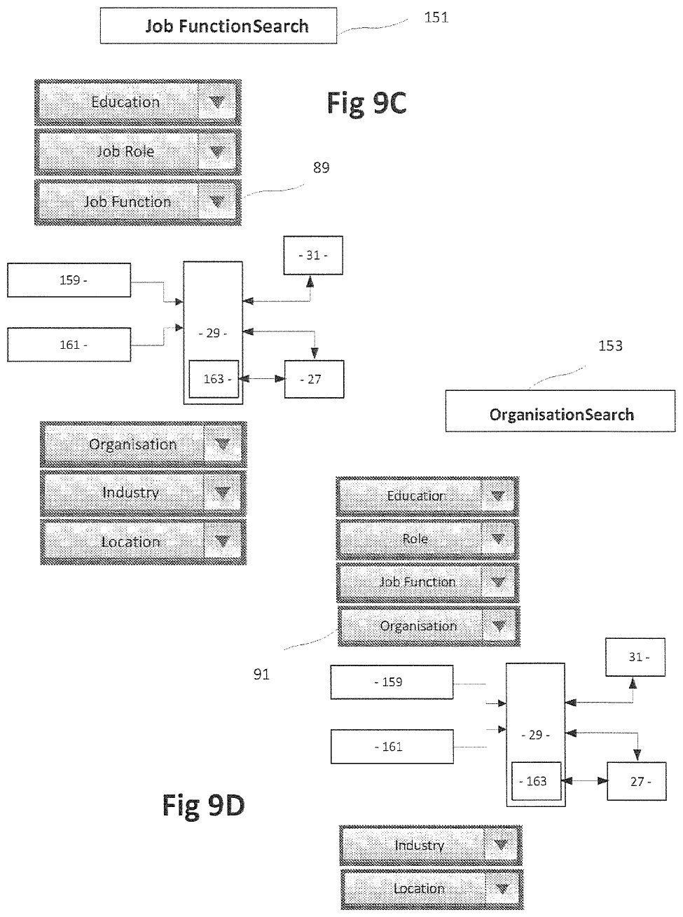

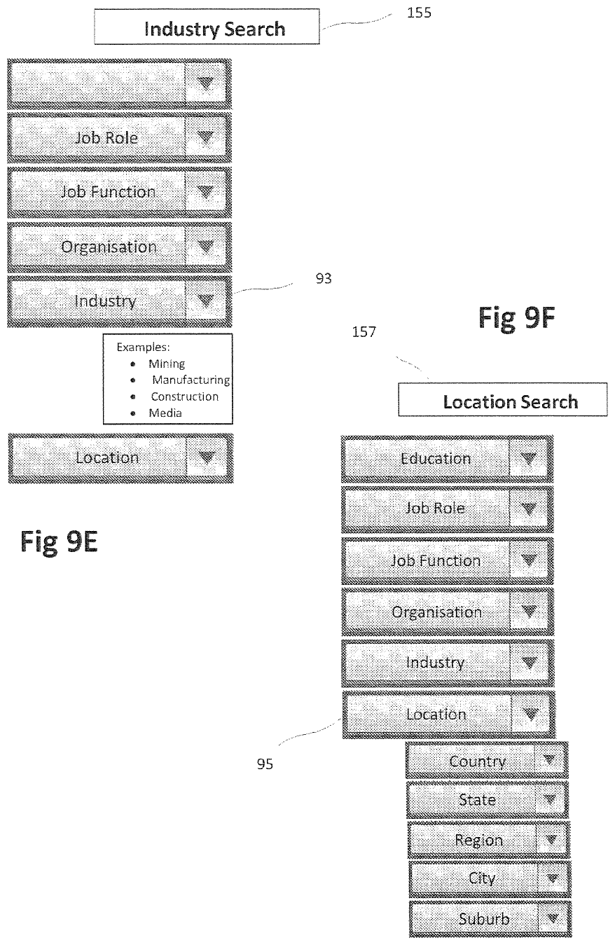

In the planning system mode, the navigation menu is designed to follow the basic layout adopted in the production system mode as shown in FIG. 7B, however, as the planning system mode is invoked for a consumer to interrogate or search the data previously entered by producers into the database via the production system 11 for the purposes of identifying single or multiple pathways between nodal objects that are specified by way of the planning system 12, the philosophy behind using the navigation menu structure is different to that involved when entering data using the production system. Moreover, being more outcomes based, the ‘job role search’ category 147, which is invoked by a consumer using the ‘Job Role’ button 87 as shown in FIG. 9B, actually is the primary search category adopted for database interrogation or searching purposes.

The ‘education search’ category 149 shown in FIG. 9A, which is invoked by a consumer asserting the ‘Education’ button 85, is primarily an input category, rather than a search category, although it may be used to refine a search. The other categories, such as, the ‘job function search’ category 151 in FIG. 9C, the ‘organisation search’ category 153, the ‘industry search’ category 155 shown in FIG. 9E and the ‘location search’ category 157 shown in FIG. 9F, which are respectively invoked by a consumer asserting the ‘Job Function’ button 89, the ‘Organisation’ button 91, the ‘Industry’ button 93 and the ‘Location’ button 95, are designed to be used to refine the search, when the number of responses from conducting the primary job role search is too large to work with.

Examples of typical fields that may be selected from the different categories are shown in Table A below:

TABLE A

| Education | Industry | Job-role | Location |
|---|---|---|---|
| Field - eg | Field - eg | Field - eg | Field - eg |
| Science | Accommodation | Accountant | Hobart |
| Engineering | Agriculture | Accounting | Burnie |
| Information | Arts | Clerk | Melbourne |
| Technology | Construction | Acupuncturist | Geelong |
| Academia | Education | Aged Carer | Sydney |
| Education | Electricity | Audiologist | Brisbane |
| Medicine | Financial | Barrister | Townsville |
| Trade | Health Care | Beauty | London |
| Service | Manufacturing | Therapist | New York |
| Government | Mining | Betting Clerk | Ottowa |
| | | Biologist | |
| | | Blacksmith | |

The planning system 12 is designed to permit a consumer to specify search parameters to initiate the search after asserting the ‘Job Role’ button 87 in the primary ‘job search’ category 147; and the ‘Job Function’ button 89 in the ‘job function’ category 151 and the ‘Organisation’ button 91 in the ‘organisation search’ category 153 of the secondary level searches in a number of ways. A manual process 159 for entering a ‘from’ job role, job function and/or organisation manually into a field is provided via the applicable drop-down menu for configuring the search data into beginning specification search data, and similarly a ‘to’ job role, job function and/or organisation is provided for configuring the search data into end specification search data.

An example of how the home screen would look after asserting the ‘Find’ press button 65 and entering a job role, location and a specific purpose filter for further than defining the search, which are displayed in fields 150a, 160b and 160c, respectively, is shown in FIG. 6A.

Alliteratively, there is a CV stripping process 161 for a user entering a consumer's curricula vitae (CV) according to a prescribed format, where the job role, job function and/or organisation of the consumer is stripped by a process to populate the relevant ‘from’ and ‘to’ fields and define the pathway to be searched.

In either case, the initial set of search parameters that are entered using the various categories to define the ‘from’ nodal object and the ‘to’ nodal object within the database 21 are deployed by the process management engine 29 in an initial search strategy process 49₁ to interrogate the database using the database interrogating process 51 to locate any ‘from’ nodal objects that are linked by a direct pathway to a ‘to’ nodal object or vice versa, and then the results processing module 53 is engaged to receive and process the results Depending upon the searching parameters that are set for configuring the planning system 12, the results processing module 53 then invokes the database interrogating process 51 using subsequent searching strategies 492 to 49, to locate any intermediary nodal objects that define pathways of different level indirect linkages between the ‘from’ and ‘to’ nodal objects.

Additionally, or alternatively, depending upon the number of responses received and if too large, the results processing module 53 invokes a process to direct the process management engine 29 by way of the user interface 27 to request the user to refine the search by entering further secondary categories to filter the search results further.

In the present embodiment, the process management engine 29 includes a search category alert process 163, whereby if a user enters a job role, job function or organisation within the applicable category that does not exist, then the user interface 27 is invoked to alert the user of the situation and notify the user when the data processing system 10 can accommodate the particular category search parameter.

The search category alert process 163 is designed to simultaneously inform the administrators of the data processing system 10 of the particular non-existent category search parameter and invoke an internal organisational process to locate a prospective producer having the non-existent category search parameter as part of their profile and invite them to become a producer of the data processing system. Once the prospective producer enters their data into the database 21, the producer creation process 41 is programmed to alert the search category alert process 163 of the existence of the previously non-existent category search parameter. The search category alert process 163 is programmed to invoke the user interface 27 and send a message notifying the consumer who previously entered the non-existent category search parameter that such now exists and a search including the parameter can now be undertaken.

The ‘industry search’ category 155 and ‘location search category 157, which are invoked by asserting the ‘Industry’ button 93 and the ‘Location’ button 95, respectively, are lower level search categories and in the present embodiment provide only for entering industry types and locations by way of the manual process 159, but in other embodiments, the CV stripping process 161 is provided to extract relevant data. In either case, the search category alert process 163 is provided in order for non-existent search category parameters to be upgraded.

It will be appreciated that whilst the present embodiment uses the particular filter buttons and sub-menu arrangements shown, variations or alternatives to these may be used in different embodiments.

As shown in FIGS. 6, 10 and 11, the output user interface 59 has a pane 165 for displaying the output data in respect of nodal objects sourced from the database 21 as a result of processing by the data processing system 10 diagrammatically as circles 167 representing career nodes 33, and directly related nodal objects that are linked by a lineal representation or line 169 representing links 35 interconnecting the circles 167.

As shown in FIG. 6, when a user first accesses the client application 25 and arrives at the home screen, the output user interface 59 displays a random assortment of coloured circles 167, each one representing a different user, chosen at random. The size of the coloured circle 167 represents the length of the real or actual path of the user. The darkness of the coloured circle 167 represents the amount of interactivity the user has had with the system, for example the darker being more active, and the colour of the coloured circle 167 represents the latest educational field that the user's current career node is associated with.

The coloured circles 167 are linked to other coloured circles based on their similarity to the other coloured circles on the page. The coloured circles 167 are not static and both move around the pages well is fade in and out to expose the user to new users over time. This is a random discovery page operating dynamically in real time so uses with an account will not necessarily see other users they are already connected to as represented by a coloured circle.

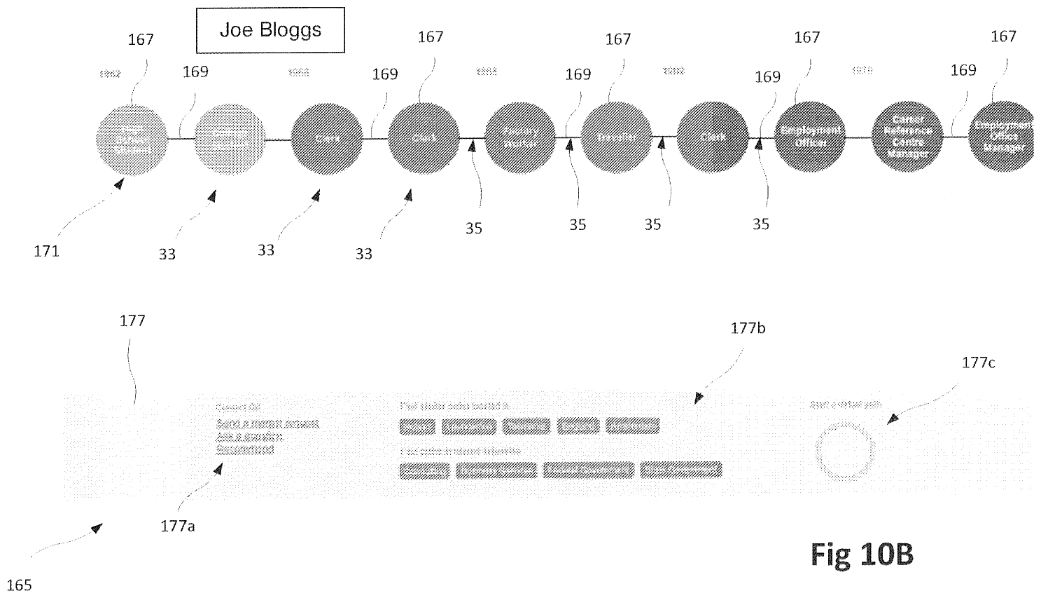

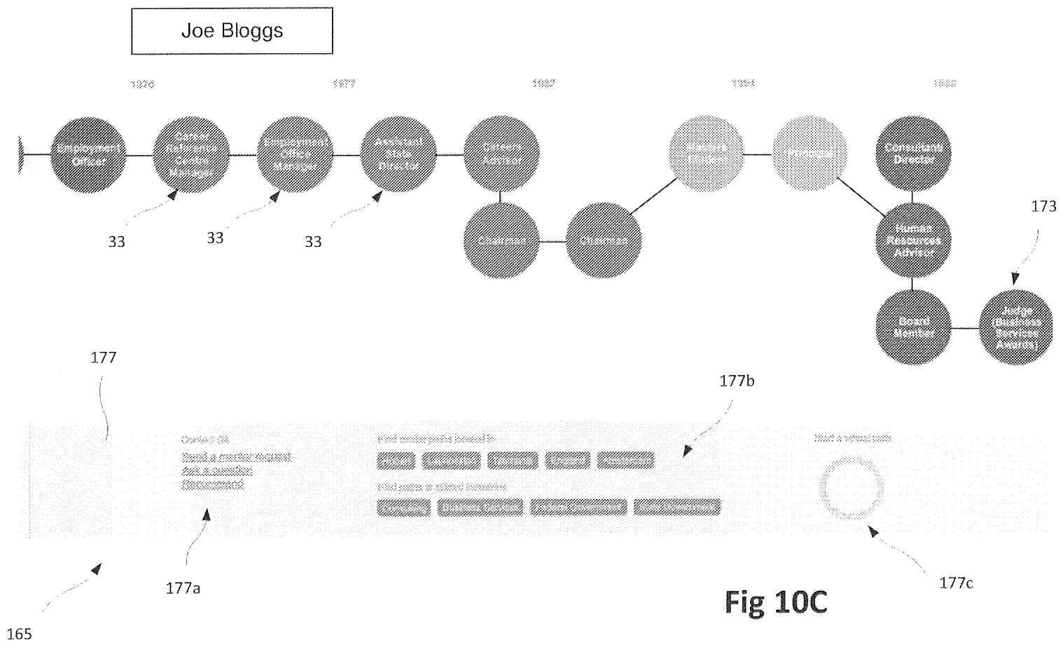

The interface generator 55 operates the input user interface layout 57 and the output user interface 59 to allow a user with a cursor to hover over a coloured dot 167 and reveal the basic details of the user—user/name, current job-role and location, as shown in FIG. 10A. Clicking on the name will take the user to the profile page of the particular user are represented by the coloured circle.

Thus users can register and create an account and profile, or update their profile using the ‘Share’ button 67, and users can also search for other users based on available criteria, such as career path node and location using the ‘Find’ 65. They are also able to access other sections of the website, such as Login/Profile, about and Contact sections of the client application.

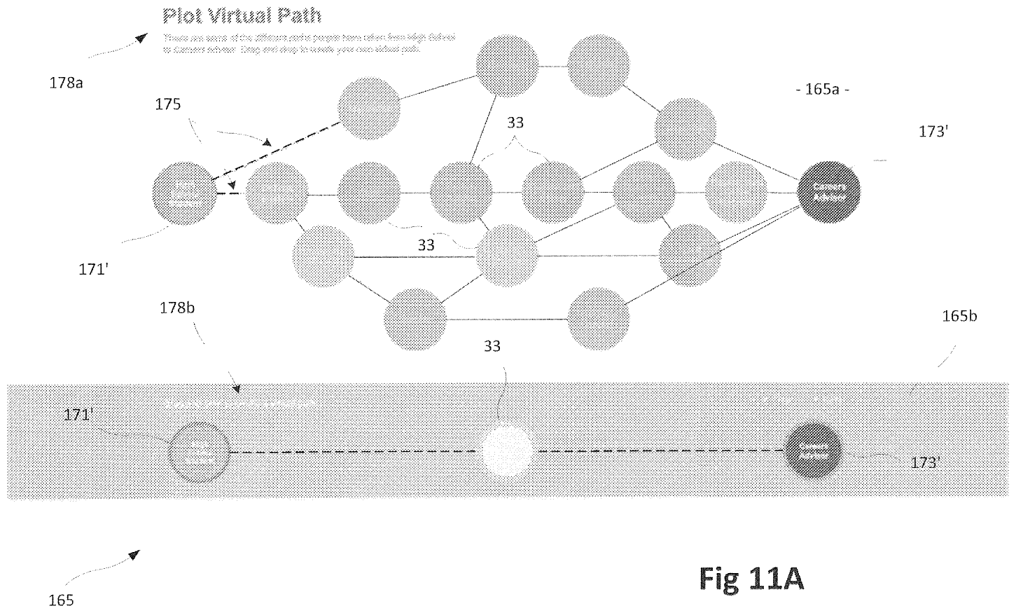

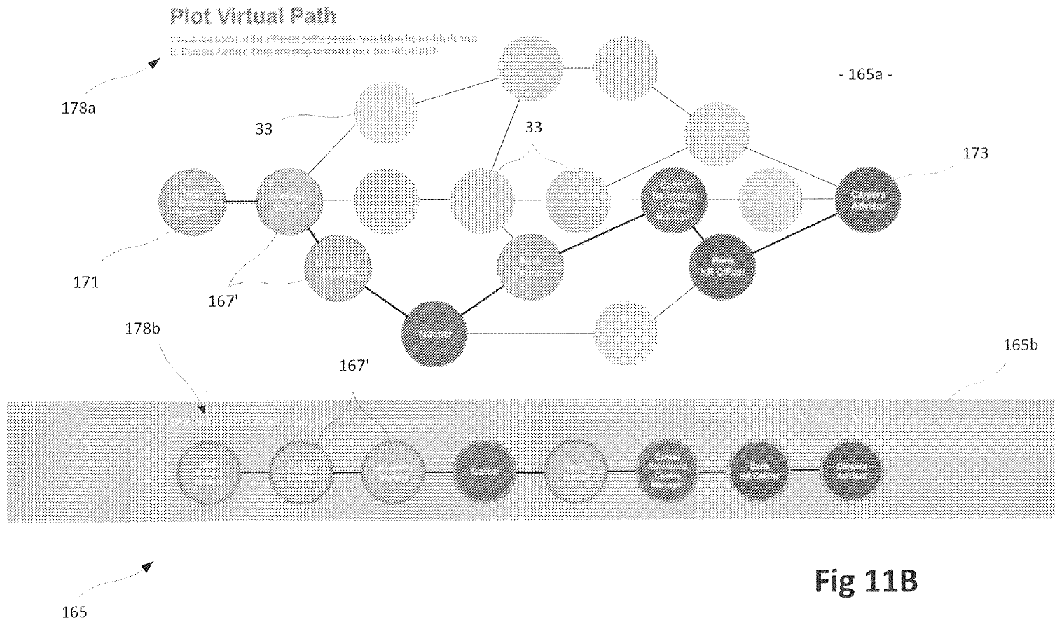

As shown in FIGS. 10B, 10C and 11, when a user actually conducts a search and invokes the planning means 12 by selecting the appropriate fields to generate the search criteria and activating the ‘Find’ button, a new display pane 165 is generated by the output user interface 59, where the nodes 33 are displayed sequentially from one end of the pane 165 to the other end of the pane, so that:
the node displayed at one end of the pane is a ‘from’ nodal object associated with the beginning specification of the beginning specification search data to establish an initial ‘starting’ node 171 in the case of showing the actual pathway of a producer, or a ‘from’ node 171′ in the case of showing a virtual pathway of a consumer, and
the node displayed at the other end of the pane is a ‘to’ nodal object associated with the ending specification of the ending specification search data to establish a final ‘ending’ node 173 in the case of showing the actual pathway of the producer, or a ‘to node 173’ in the case of showing the virtual pathway of the consumer.

In this manner, the nodes 33 collectively form one actual pathway between the ‘starting’ node 171 and the ‘ending’ node' 173 or one or more virtual pathways between the ‘from’ node 171′ and the ‘to’ node 173.

The output user interface 59 is able to display multiple branches 175 from one node 33 to other intermediary nodes 33 between the ‘from’ node 171′ and the ‘to’ node 173′ when creating a virtual pathway, where there may be more than one pathway between the ‘from’ node and the ‘to’ node.

As shown in FIGS. 10B and 10C, facility is provided for showing the actual pathway of a producer. In the example shown in the drawing, the producer Joe Bloggs has entered their educational details as a high school student as their ‘starting’ node 171 in FIG. 10A, and their current community-based role as a judge of Business Services Awards as their ‘ending’ node 173 in FIG. 10B.

In the present embodiment, different colours are used to represent different levels of informational content relating to the career of a person. For example lime green is used to show educational content, teal green is used to show job role content, grey is used to show extended time off during the career, sky blue is used to show self-employment and tan is used to show community role activity. Of course it would be appreciated that other means of distinguishing informational content may be used in other embodiments, such as using shapes or other iconic symbols instead of colour.

In this example, the output user interface 59 also displays a ribbon 177 within which various menu options forming part of the menu system are displayed as hyperlinks. These options include sending a mental request, asking a question or making a recommendation at 177a, finding similar paths located in other locations and paths in related industries at 177b, and starting a virtual path as a consumer at 177c.

With a consumer creating or plotting a virtual pathway, as shown in FIG. 11, the pane 165 is divided into a main display area 165a for displaying the output data and a scratchpad display area 165b for the user to create a virtual pathway. The user achieves this by choosing selected intermediary nodes 167′ from the main display area 165a and dragging and dropping them from the main display area to the scratchpad display area 167b.

As is shown, the user is prompted to plot a virtual path by various messages 178a and 178b shown on the main display area 165a and the scratchpad display area 165b, respectively

In order for the output user interface 59 to perform certain of the functions provided by the planning system 12 when operating in the planning mode, the process management engine 29 includes: a nodal object generation process 179. an arm's length communication process 181, a virtual pathway creation process 183 and a virtual display validating process 185

The nodal object generation process 179 is programmed to follow a process that interacts with the search process adopted by a consumer as shown by the flowchart in FIG. 12C. Accordingly, the nodal object generation process 179 includes:
(i) receiving the beginning specification from the user interface to establish the ‘from’ nodal object;
(ii) providing the user interface with prescribed list information from which the end specification can be selected to establish the ‘to’ nodal object; and;
(iii) applying the beginning specification and the end specification to the initial searching strategy process and the subsequent searching strategy process as required.

The arm's length communication process 181 is specifically designed for managing queries from consumers via the menu system and establishing mentoring requests as provided by the hyperlinks at 177a. Moreover, the communication process 166 is programmed to:
(i) receive a producer contact query from the user interface directed to related nodal objects of a producer displayed in the graphical presentation to the user;
(ii) access the data store to retrieve contact information from the user information of a producer associated with creating the related nodal objects;
(iii) follow an agreed to protocol preserving privacy and the provision of personal information, which may involve external communication by an administrator of the data processing system separately to the relevant producer and consumer, ensuring anonymity, and receiving assurances from both parties; and (iv) provide the user interface with the retrieved contact information for displaying to the user.

The process followed by the arm's length communication process 181 is further described in the flowchart shown in FIG. 12D

The virtual pathway creation process 183 is programmed to interact with the output user interface 55 to graphically present data to the user and create a virtual pathway, dependent upon user selections. Accordingly, the virtual pathway creation process 183 is designed to:
(i) receive selections of intermediary nodal objects from the user interface to form a virtual pathway from the ‘from’ nodal object to the ‘to’ nodal object, disassociating the related nodal objects from the producer pathway as determined by the selection;
(ii) link related nodal objects between different producers as determined by the selection, retaining producer information between related nodal objects extracted from the database; and
(iii) store the virtual pathway as virtual data in the data store separately of the data populating the database as created by the producer creation process.

The process followed by the virtual pathway creation process 183 is further described in the flowchart shown in FIG. 12E.

The virtual display validating process 185 is provided to ensure that the virtual pathway is valid based upon data pertaining to actual pathways stored within the database 21 and is invoked by the user interface 27. The virtual display process 179 is programmed to check that each selected node 167′ chosen from the main display area 165a is directly connected to pre-selected predecessory and successory nodes that are directly related in an actual pathway before verifying that the virtual pathway is valid.

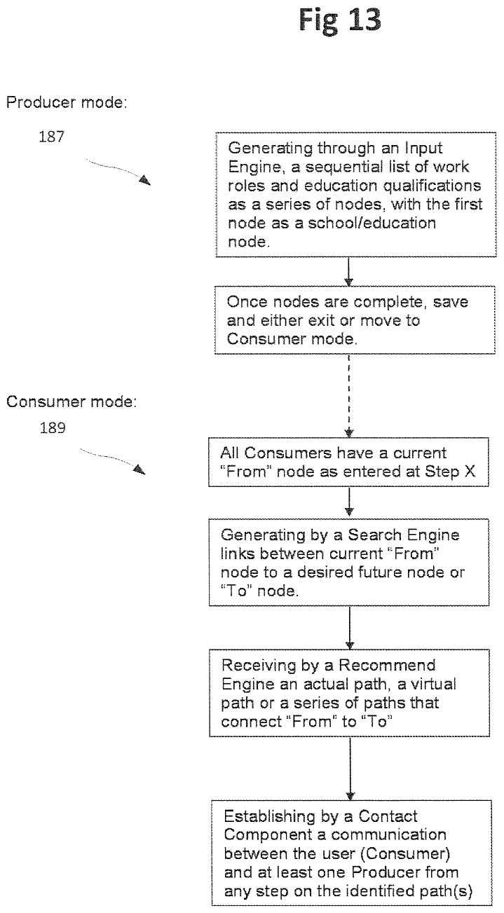

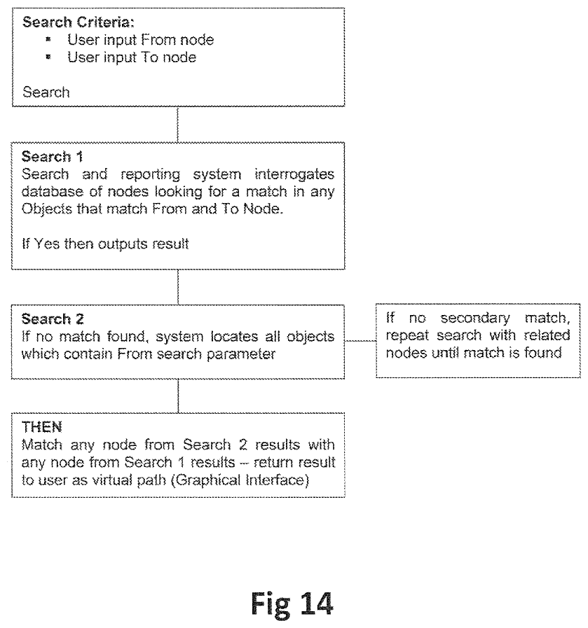

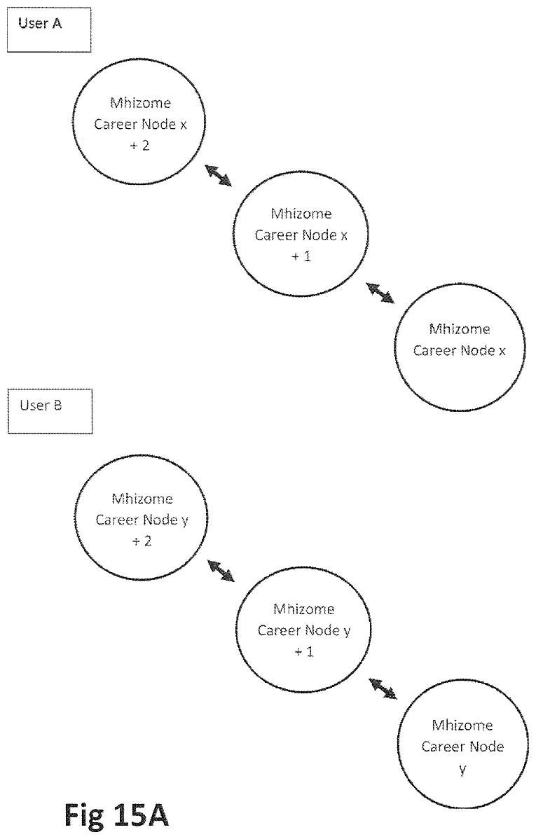

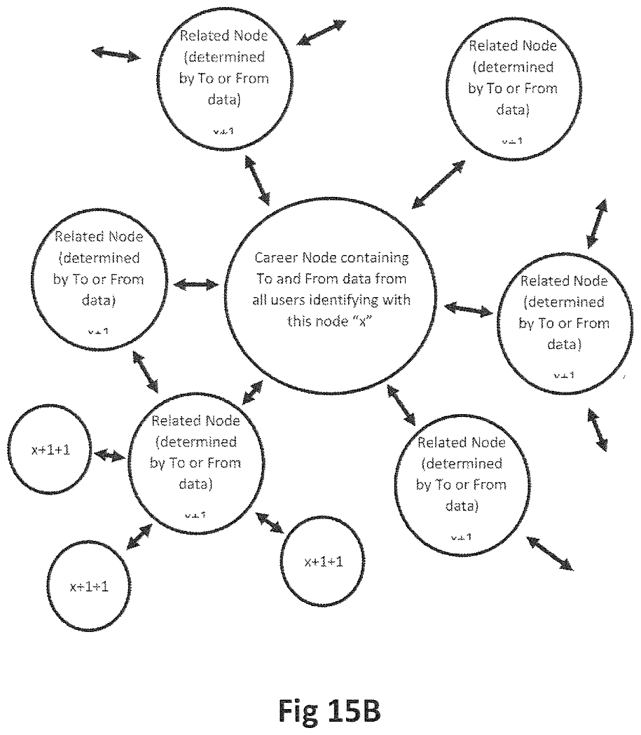

Having described the structure of the system, regard will now be made to the overall process methodology undertaken by the data processing system 10, and described with reference to FIG. 13. FIG. 14 and FIGS. 15.

The general system process is described in FIG. 13 with respect to both the producer mode at 187 and the consumer mode at 189.

Essentially, the data processing system 10 and the methods associated with its use in the present embodiment are concerned with the nodal categorization of career information supplied by users of the system and the retrieval of the nodal data to dynamically establish connections from one node to another when no direct path appears to exist. The search methodology provided by the planning system 12 explores all relational nodes to establish links between nodes based solely on a starting criterion and an ending search criterion. This search methodology is essentially shown in FIG. 14.

For example:
A consumer visits the system website.
The consumer enters their current career role data (which is automatically categorized by the system into a Career Node “x”) shown in FIG. 15.
The consumer then identifies a Career Node that they are interested in achieving—Node “Y”.

At this point the planning system 12 begins a dual ended search. The first part of the search interrogates the database for any direct connection between Node “x” and Node “y”. If the relationship exists the result is returned to the user and the search ends

If no direct relationship exists between “x” and “y”, the system interrogates all nodes associated with x AND y to see if a pathway can be established between nodes related to “x” or “y”.

To understand this extended nodal relationship search it is important to understand the data structures within each Career Node, which arises from the Career Node data set stored by the DBMS 31 in the database 21.

All users of the system are encouraged to be both producers (for the benefit of others) and consumers (for their own benefit).

When users visit the website of the system as producers, they are encouraged by means of the menu system to enter information about their current and past career roles and education qualifications. Some of this data forms the core of the Career Node data set, including:
Roles (job titles—from drop list)
Qualifications (from drop list)
Industry (from drop list)
Location (from drop list).

When users visit the website as consumers, they are encouraged by means of the search process to enter information about a future role they aspire to and the search process treats their current role as the ‘from’ node.

The ‘to’ and from' data forms the bond between one Career Node and another, The ‘to’ and ‘from’ bonds also create a relationship to another Career Node.

This is central to the system because each related node is an x+1 node which in turn has its own ‘to’ and from' data bonds to other Career Nodes giving an x+1+1 relationship. This relationship is illustrated in FIG. 15A.

Another central feature of the system is the categorisation of the Career Node data. With many thousands of users entering nodal data sets, the system is designed to overlay and establish connections between nodes from all users to form a large data pool from which virtual pathways may be plotted. This is illustrated in FIG. 15B.

Each of these +1 nodes can and will have their own +1 nodes drawn from their own independent Career Node data sets, creating an exponentially growing complexity of links (pathways) between nodes.

In this way links can be constructed from Node “x” to Node “y” when no actual individual's career path matches. This is achievable because the millions of paths generated by the nodal categorization of data by the system and the search methodology allow for the overlay of many thousands of actual real life paths into a nodal network of virtual paths that the consumer can explore as potential pathways from one node to another.

Some of these system outputs may be simple and others may involve many nodal connections to get from Node “x” to Node “y”.

It should be appreciated that the scope of the invention is not limited to the particular embodiments described herein and that other embodiments of the invention may be envisaged including variations or modifications to the data processing system and method that do not detract from the spirit or scope of the invention. For example, the invention may be applicable to other planning processes, which have elements of space, time and particular components, such as travel plans using different geographical locations and travel modes etc., and cooking using ingredients and recipes etc.

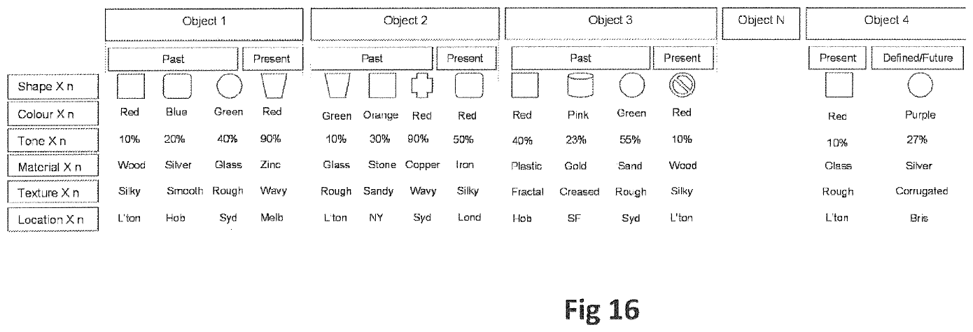

Moreover, FIG. 16 shows schematically how the data processing system and methodology can be applied to various types of structured data sets to achieve equifinality as a consequence of using the searching and filtering technique previously described. In this schematic, the dataset is comprised of ‘n’ objects, namely Object 1, Object 2, Object 3, Object 4 . . . Object N, each of which have one or several past states, a present state and a potential defined/future state/s that can be constructed from combinations of the past or present states of other objects. As shown, the current state of Object 1 is: Trapezoid, Red, 90%, Zinc, Melb, each of which constitute a node.

Objects contain categories and sub-categories, each made up of linear iterations of states. For example, Object 1 has previously changed state from Square to Rounded Square, to Circle and is currently Trapezoid—each of which is a node. For search purposes, nodes are connected to their previous ‘From’ node/s and to previous or present ‘To’ nodes. Although states and nodes are sequential for Objects, they are time independent for Search Objects.

In this system, the primary category is Shape and this would be the primary search category. The other categories (e.g. Colour, Tone) would be used to refine or filter a search.

Object 4 is the Search Object, so its past states are not important—only the Present ‘From’ state is considered and Object 4 wants to move to the desired Defined/Future ‘To’ state. The system will locate Objects which have moved from Square to Circle (e.g. Objects 1 and 3) and will use the other categories (e.g. Colour, Tone) to filter the search if there are significantly more than the two objects (in the present instance Objects 1 and 3) that satisfy the search.

The process followed to perform a search, the subject of which is Object 4, comprises the following steps:
(1) Step 1—Enter past states and present ‘From’ state (i.e. the searched object)
(2) Step 2—Define future object/state being the ‘To’ node/s—in this case Circle, with secondary categories Purple, 27% etc.
(3) Step 3—Function:—Search for Objects/Categories/States.

The result of the search is then analysed by comparing the defined object/state with the search result, where the outcome is displayed as a linear iteration of states from the defined object to the searched object.

1-19. (canceled)

20. A planning system synthesized by a data processing system interrogating a database of data representing nodal objects in a data store,
A) each nodal object:
(i) having informational content characterizing the nodal object, the informational content associated with one nodal object being related to a producer and distinguishable from informational content associated with another nodal object;
(ii) having one or more links to other nodal objects;
(iii) being linked to a predecessory nodal object or a successory nodal object to represent a pathway;
B) each link being representative of said pathway as traversed by a producer; and
C) a plurality of links to or from a nodal object being representative of the pathways of the same or different producers;
the data processing system including:
a memory comprising instructions; and
one or more computer processors, wherein the instructions, when executed by the one or more computer processors, cause one or more computer processes, engines and interface to perform operations comprising:
(a) initiating and deploying discrete instances of a plurality of searching strategy processes in a looping routine by a process management engine, each instance adopting a different searching strategy to the searching strategy of a preceding instance in response to input search data having a beginning specification of a nodal object that establishes a ‘from’ nodal object, and an end specification of a nodal object that establishes a ‘to’ nodal object, whereby the ‘from’ nodal object and the ‘to’ nodal object relatively constitute terminal nodes of a network of links between the nodal objects, each link representing a pathway that can be traversed by a producer;
(b) interrogating the database by a database interrogating process using a deployed instance of a searching strategy process commencing with an initial searching strategy process and progressing with one or more subsequent searching strategy processes as determined by the process management engine, and generating results from the interrogating;
(c) receiving and processing the results of the interrogating of the database at (b) by a results processing engine comprising:
(i) ascertaining the result of the initial searching strategy process that locates nodal objects and determining whether the searching strategy of that process is satisfied, or whether a different searching strategy needs to be applied; and
(ii) outputting reporting output data if the searching strategy of the initial searching strategy process is satisfied; and
(iii) invoking the looping routine by initiating another interrogating of the database for nodal objects according to the different searching strategy of a subsequent searching strategy process if invoked by the process management engine; and
(iv) outputting reporting output data if the different searching strategy of the subsequent searching strategy process is satisfied; or
(v) if the subsequent searching strategy process is not satisfied, invoking a further loop or loops of the looping routine by repeating preceding steps (iii) and (iv);
(d) controlling of the interrogating of the database by the database interrogating process and the results processing engine is performed by the management process engine deploying:
(i) the initial searching strategy process using the input search data to locate any ‘from’ and ‘to’ nodal objects that are linked to each other directly by a single pathway without any intermediary nodal object or objects being linked between these terminal nodes; and
(ii) the subsequent searching strategy process or processes in response to activation of the results processing engine locating both:
(A) any ‘from’ nodal objects that are linked to a ‘to’ nodal object indirectly by a plurality of pathways including one or more intermediary nodal objects between the terminal nodes; and
(B) any ‘to’ nodal objects that are linked to a ‘from’ nodal object indirectly by a plurality of pathways including one or more intermediary nodal objects between the terminal nodes; and
(e) configuring search data input by a user interface into beginning specification search data and end specification search data and inputting the configured search data to the process management engine, and configuring output data by the user interface that is to be reported from the process management engine into graphical presentation to the user;
wherein the searching strategy process comprises:
(i) a search of the database by the database interrogating process interrogating the database for locating direct single pathway connections between terminal nodal objects in an instance of the looping routine when the initial searching strategy process is deployed;
(ii) selectively a dual end search of the database by the database interrogating process interrogating the database for locating indirect plural pathway connections between terminal nodal objects in another instance of the looping routine when one or more of the subsequent searching strategy processes are deployed, each instance invoking one search for ‘from’ nodal objects corresponding to the beginning specification search data and another search for ‘to’ nodal objects corresponding to the end specification search data sourced from the user interface by the process management engine;
(iii) forming a plurality of virtual pathways between the terminal nodes from the results of the dual end search, including one or more intermediary nodal objects that are linked to different producers; and
(iv) linking nodal objects between different producers, including an intermediary nodal object belonging to one producer to an intermediary nodal object belonging to a different producer, thereby creating the virtual pathway to satisfy the subsequent searching strategy process invoked by the process management engine.

21. A planning system as claimed in claim 20, wherein the user interface includes a filter to facilitate a user inputting data and initiating the subsequent searching strategy process or a plurality of subsequent searching strategy processes to select a pathway level to apply for extracting intermediary nodal objects from the output data for graphical presentation to the user, whereby the pathway level corresponds to the number of pathways linking the terminal nodes either directly without any intermediary nodal objects or indirectly with intermediary nodal objects.

22. A planning system as claimed in claim 20, wherein the instructions, when executed by the one or more computer processors, cause one or more computer processes, engines and interface to perform operations comprising:
(i) receiving the beginning specification from the user interface to establish the ‘from’ nodal object;
(ii) providing the user interface with prescribed list information from which the end specification can be selected to establish the ‘to’ nodal object; and
(iii) applying the beginning specification and the end specification to the initial searching strategy process and the subsequent searching strategy process respectively.

23. A planning system as claimed in claim 20, wherein the instructions, when executed by the one or more computer processors, cause one or more computer processes, engines and interface to perform operations comprising populating the database by a producer creation process with discrete nodal objects associated with a producer sequentially occurring at different chronological stages commencing with a beginning specification and finishing with an ending specification, and including specifications for all intermediary nodal objects, the producer creation process operable to:
(i) receive specification data and producer data from the user interface for each nodal object created by the producer, along with other informational content characterizing the nodal object;
(ii) link successive nodal objects and relate them so that all of the nodal objects represent a pathway from the nodal object with the beginning specification to the nodal object with the ending specification;
(iii) populate the database with data in respect of each of the related nodal objects in respect of which informational content is received; and
(iv) associate producer information with each of the related nodal objects populating the database.

24. A planning system as claimed in claim 23, wherein the instructions, when executed by the one or more computer processors, cause one or more computer processes, engines and interface to perform operations comprising:
(a) receiving a producer contact query from the user interface directed to related nodal objects of a producer displayed in the graphical presentation to the user,
(b) accessing the data store to retrieve contact information from the user information of a producer associated with creating the nodal objects; and
(c) providing the user interface with the retrieved contact information for displaying to a user.

25. A planning system as claimed in claim 20, including a virtual pathway creation process to use with the output data graphically presented by the user interface, the virtual pathway creation process comprising:
(i) receiving selections of intermediary nodal objects from the user interface to form a virtual pathway between two intermediary nodal objects, somewhere between the ‘from’ nodal object and the ‘to’ nodal object, disassociating certain nodal objects from the virtual pathway as determined by the selection;
(ii) linking nodal objects between different producers where no previous link exists, including linking an intermediary nodal object belonging to one producer to an intermediary nodal object belonging to a different producer, thereby creating the virtual pathway as determined by the selection, retaining producer information between nodal objects extracted from the database, and
(iii) storing the virtual pathway as virtual pathway data in the data store separately from the data populating the database as created by the producer creation process.

26. A planning system as claimed in claim 20, wherein the user interface includes by an interface generator:
(a) generating an input user interface layout to receive and configure the search data: and (b) generating an output user interface to receive and configure the output data in the form of the graphical presentation to the user;
wherein:
A) the input user interface layout has a field configuring the search data into beginning specification search data and end specification search data; and
B) the output user interface has a pane displaying the output data in respect of nodal objects sourced from the database as a result of processing by the data processing system diagrammatically as nodes, and directly related nodal objects that are linked by a lineal representation interconnecting the nodes;
whereby the nodes are displayed sequentially from one end of the pane to the other end of the pane, so that the node displayed at one end of the pane is a nodal object associated with the beginning specification of the beginning specification search data to establish a ‘from’ node and the node displayed at the other end of the pane is a nodal object associated with the ending specification of the ending specification search data to establish a ‘to’ node, so that the nodes collectively form one or more actual pathways between the ‘from’ node and the ‘to’ node.

27. A planning system as claimed in claim 26, wherein the user interface is able to display multiple branches from one node to other intermediary nodes between the ‘from’ node and the ‘to’ node.

28. A planning system as claimed in claim 26, wherein the pane is divided into a main display area for displaying the output data and a scratchpad display area for the user to create a virtual pathway using selected nodes from the main display area by dragging and dropping a chosen node from the main display area to the scratchpad display area.

29. A planning system as claimed in claim 28, wherein the interface generator includes a virtual display validating process for checking that selected nodes from the main display area are connected as related nodes in the actual pathway either:
(a) directly by a single pathway without any intermediary nodal objects being linked between the selected nodes; or
(b) indirectly by a plurality of pathways including one or more intermediary nodal objects between the selected nodes;
before verifying that the virtual pathway is valid.

30. A method of interrogating a database of data representing nodal objects,
A) each nodal object:
(i) having informational content characterizing the nodal object, the informational content associated with one nodal object being related to a producer and distinguishable from informational content associated with another nodal object;
(ii) having one or more links to other related nodal objects;
(iii) being linked to a predecessory nodal object or a successory nodal object to represent a pathway;
B) each link being representative of a pathway of a producer; and
C) a plurality of links to or from a nodal object being representative of the pathways of the same or different producers;
the method including:
(a) initiating and deploying discrete instances of a plurality of searching strategies in a looping routine, each instance adopting a different searching strategy to the searching strategy of the preceding instance in response to input search data having a beginning specification of a nodal object that establishes a ‘from’ nodal object, and an end specification of a nodal object that establishes a ‘to’ nodal object as determined by a user specification, whereby the ‘from’ nodal object and the ‘to’ nodal object relatively constitute terminal nodes of a network of links between the nodal objects, each link representing a pathway that can be traversed by a producer;
(b) interrogating the database using a deployed instance of a searching strategy commencing with an initial searching strategy and progressing with different searching strategies, and generating results from the interrogating;
(c) receiving and processing the results of the interrogating of the database by:
(i) ascertaining the result of the initial searching strategy that locates nodal objects and determining whether the searching strategy of that process is satisfied, or whether a different searching strategy needs to be applied; and
(ii) outputting reporting output data if the searching strategy of the initial searching strategy process is satisfied; and
(iii) invoking the looping routine by initiating another interrogation of the database for nodal objects according to the different searching strategy as ultimately determined by the user specification;
(d) controlling the interrogating of the database according to the determination of the user specification by deploying
(i) the initial searching strategy using the input search data to locate any ‘from’ and ‘to’ nodal objects that are linked to each other directly by a single pathway without any intermediary nodal object or objects being linked between these terminal nodes; and
(ii) the different searching strategy or strategies in response to locating both:
(A) any ‘from’ nodal objects that are linked to a ‘to’ nodal object indirectly by a plurality of pathways including one or more intermediary nodal objects between the terminal nodes; and
(B) any ‘to’ nodal objects that are linked to a ‘from’ nodal object indirectly by a plurality of pathways including one or more intermediary nodal objects between the terminal nodes; and
(e) configuring search data input by a user into beginning specification search data and end specification search data and configuring output data into a graphical presentation to the user;
wherein the searching strategy comprises:
(i) searching the database by interrogating the database for locating direct single pathway connections between terminal nodal objects in an instance of the looping routine when the searching strategy is the initial searching strategy;
(ii) selectively searching the database dual endedly by interrogating the database for locating indirect plural pathway connections between terminal nodal objects in each instance when the searching strategy is one of the different searching strategies, each instance invoking one search for ‘from’ nodal objects corresponding to the beginning specification search data and another search for ‘to’ nodal objects corresponding to the end specification search data;
(iii) forming a plurality of virtual pathways between the terminal nodes from the results of the dual end search, including one or more intermediary nodal objects that are linked to different producers; and
(iv) linking nodal objects between different producers, including an intermediary nodal object belonging to one producer to an intermediary nodal object belonging to a different producer, thereby creating the virtual pathway to satisfy the different searching strategy.

31. A method as claimed in claim 30, including accessing the database by:
generating an input user interface layout configuring input search data and an output user interface configuring output data in the form of a graphical presentation;
providing fields on the input user interface layout configuring the search data into beginning specification search data and end specification search data on the input user interface layout;
presenting a pane on the output user interface displaying the output data in respect of nodal objects sourced from the database diagrammatically as nodes, and linking directly related nodal objects by a lineal representation interconnecting the nodes as a result of processing; and
displaying the nodes sequentially from one end of the pane to the other end of the pane, so that the node displayed at one end of the pane is a nodal object associated with the beginning specification of the beginning specification search data to establish a ‘from’ node and the node displayed at the other end of the pane is a nodal object associated with the ending specification of the ending specification search data to establish a ‘to’ node, so that the nodes collectively form one or more actual pathways between the ‘from’ node and the ‘to’ node.

32. A method as claimed in claim 30, including filtering user input data and initiating the subsequent searching strategy by selecting a pathway level to apply for extracting intermediary nodal objects from the output data for graphical presentation to the user, whereby the pathway level corresponds to the number of pathways linking the terminal nodes either directly without any intermediary nodal objects or indirectly with intermediary nodal objects.

33. A method as claimed in claim 30, including:
(i) receiving the beginning specification from input search data to establish the ‘from’ nodal object;
(ii) receiving prescribed list information from which the end specification can be selected to establish the ‘to’ nodal object; and
(iii) applying the beginning specification and the end specification to the initial searching strategy and the subsequent searching strategy respectively.

34. A method as claimed in claim 30, including:
populating the database with discrete nodal objects associated with a producer sequentially occurring at different chronological stages commencing with a beginning specification and finishing with an ending specification, and including specifications for all intermediary nodal objects, and further:
(i) receiving specification data and producer data from the user interface for each nodal object created by the producer, along with other informational content characterizing the nodal object;
(ii) linking successive nodal objects and relating them so that all of the nodal objects represent a pathway from the nodal object with the beginning specification to the nodal object with the ending specification,
(iii) populating the database with data in respect of each of the related nodal objects in respect of which informational content is received; and
(iv) associating producer information with each of the related nodal objects populating the database.

35. A method as claimed in claim 30, including:
(a) receiving a producer contact query directed to related nodal objects of a producer displayed in the graphical presentation to the user;
(b) accessing the database to retrieve contact information from the user information of a producer associated with creating the nodal objects; and
(c) providing the user interface with the retrieved contact information for displaying to a user

36. A method as claimed in claim 30, including:
(i) receiving selections of intermediary nodal objects from the user interface to form a virtual pathway between two intermediary nodal objects, somewhere between the ‘from’ nodal object and the ‘to’ nodal object, disassociating certain nodal objects from the virtual pathway as determined by the selection;
(ii) linking nodal objects between different producers where no previous link exists, including an intermediary nodal object belonging to one producer to an intermediary nodal object belonging to a different producer, creating the virtual pathway as determined by the selection, retaining producer information between nodal objects extracted from the database, and
(iii) storing the virtual pathway as virtual pathway data separately from the data populating the database.

37. A method as claimed in claim 31, including: displaying multiple branches from one node to other intermediary nodes between the ‘from’ node and the ‘to’ node.

38. A method as claimed in claim 13, including: dividing the pane into a main display area for displaying the output data and a scratchpad display area for the user to create a virtual pathway using selected nodes from the main display area by dragging and dropping a chosen node from the main display area to the scratchpad display area.

39. A method as claimed in claim 38, including: checking that selected nodes from the main display area are directly connected as related nodes in the actual pathway either:
(a) directly by a single pathway without any intermediary nodal objects being linked between the selected nodes; or
(b) indirectly by a plurality of pathways including one or more intermediary nodal objects between the selected nodes;
before verifying that the virtual pathway is valid.
